SEQUENCE LISTING (52 sequences)

SEQ ID NO: 1 - DNA, 60 bp, Homo sapiens
atttatcttggggaaacctcagaactggtctatttggtgtcgtggaacctcttactgctt

SEQ ID NO: 2 - DNA, 60 bp, Homo sapiens
aaagagagaagaaaaactggaaatcttattccgtgtgtgtttgggagttgcttggggttg

SEQ ID NO: 3 - DNA, 60 bp, Homo sapiens
aatacagcagtgtcatcagaagataacttgagcaccgtcatggcttaatgtttattcctg

SEQ ID NO: 4 - DNA, 60 bp, Homo sapiens
ggagagtttgggaactgcaataacctgggagttttggtggagtccgatgattctcttttg

SEQ ID NO: 5 - DNA, 60 bp, Homo sapiens
tctttgttctttgtcacagggactgaaaacctctcctcatgttctgctttcgattcgtta

SEQ ID NO: 6 - DNA, 60 bp, Homo sapiens
ggctttgcctaagatccaagacagaataatgaatggactcaaactgccttggcttcaggg

SEQ ID NO: 7 - DNA, 60 bp, Homo sapiens
tctagaagcagccattaccaactgtaccttcccttcttgctcagccaataaatatatcct

SEQ ID NO: 8 - DNA, 60 bp, Homo sapiens
tgctgccaacttctaaccgcaatagtgactctgtgcttgtctgtttagttctgtgtataa

SEQ ID NO: 9 - DNA, 60 bp, Homo sapiens
aggtgcagcctctggaagtggatcaaactagaactcatatgccatactagatatgtttgt

SEQ ID NO: 10 - DNA, 60 bp, Homo sapiens
ctatatatttgtacaataggactgtttactgcccacctccgcctgccagcccaccccagc

SEQ ID NO: 11 - DNA, 60 bp, Homo sapiens
ttgtttgcttgcagtgctttcttaattttatggctcttctgggaaactcctccccttttc

SEQ ID NO: 12 - DNA, 60 bp, Homo sapiens
tcagttttcaggagtgggttgatttcagcacctacagtgtacagtcttgtattaagttgt

SEQ ID NO: 13 - DNA, 60 bp, Homo sapiens
caatcccacatacgcagggggaaggcttggagtagacaaaaggaaaggtctcagcttgta

SEQ ID NO: 14 - DNA, 60 bp, Homo sapiens
ttattcaataaagtatttaattagtgctaagtgtgaactggaccctgttgctaagcccca

SEQ ID NO: 15 - DNA, 60 bp, Homo sapiens
ttgtgggtgtgaaacaaatggtgagaatttgaattggtccctcctattatagtattgaaa

SEQ ID NO: 16 - DNA, 60 bp, Homo sapiens
cccggtggcacagtttgtaaactggatcgactctatcatccaacgctccgaggacaaccc

SEQ ID NO: 17 - DNA, 60 bp, Homo sapiens
aatgttcattgtaatgttactgatcatgcattgttgaggtggtctgaatgttctgacatt

SEQ ID NO: 18 - DNA, 60 bp, Homo sapiens
cggaatatctctttgacaagcacacctgggagacagtgataatgaaagctaagcctcggg

SEQ ID NO: 19 - DNA, 60 bp, Homo sapiens
tagactaccagcaaagattaaagcatgaaatgtaaaacatctgataaaacttacagcccc

SEQ ID NO: 20 - DNA, 60 bp, Homo sapiens
ggcaggaggtggaaaccccaggggctggcttttttaaaactggttttattttaattttta

SEQ ID NO: 21 - DNA, 60 bp, Homo sapiens
ggtcctgttgatcccagtctctgccagaccaaggcgagtttccccactaataaagtgccg

SEQ ID NO: 22 - DNA, 60 bp, Homo sapiens
accagatctccttcgctgactacaacctgctggacttgctgctgatccatgaggtcctag

SEQ ID NO: 23 - DNA, 60 bp, Homo sapiens
gcagtatttttgttgtgttctgttgtttttatagcagggttggggtggtttttgagccat

SEQ ID NO: 24 - DNA, 60 bp, Homo sapiens
ttcctgtggatgttttgtgtagtatcttggcatttgtattgatagttaaaattcacttcc

SEQ ID NO: 25 - DNA, 60 bp, Homo sapiens
ggagcttcaagactttgcatttcctagtatttctgtttgtcagttctcaatttcctgtgt

SEQ ID NO: 26 - DNA, 60 bp, Homo sapiens
ttggaaagctatgcctattctctaaagaatcagattggagataaagaaaagctgggaggt

SEQ ID NO: 27 - DNA, 60 bp, Homo sapiens
gccccattccctctctactcttgacagcaggattggatgttgtgtattgtggtttatttt

SEQ ID NO: 28 - DNA, 60 bp, Homo sapiens
cttaatgtacgtcttcagggagcaccaacggagcggcagttaccatgttagggaggagag

SEQ ID NO: 29 - DNA, 60 bp, Homo sapiens
ccaggtcaaaggagagaggtgggattgtgggtgacttttaatgtgtatgattgtctgtat

SEQ ID NO: 30 - DNA, 60 bp, Homo sapiens
aacagatggattaccttttgtcaaagcatcatctcaacactaacttgataattaagtgct

SEQ ID NO: 31 - DNA, 60 bp, Homo sapiens
ctgaattattggacagtctcacctcctgccatagggtcctgaatgtttcagaccacaagg

SEQ ID NO: 32 - DNA, 60 bp, Homo sapiens
attcaacccacctgcgtctcatactcacctcaccccactgtggctgatttggaattttgt

SEQ ID NO: 33 - DNA, 60 bp, Homo sapiens
ttaattatctaatttctgaaatgtgcagctcccatttggccttgtgcggttgtgttctca

SEQ ID NO: 34 - DNA, 60 bp, Homo sapiens
tgtaatgaacaccgagtggataatagaaagttgagactaaactggtttgttgcagccaaa

SEQ ID NO: 35 - DNA, 60 bp, Homo sapiens
gcccatccatctgcttacaattccctgctgtcgtcttagcaagaagtaaaatgagaaatt

SEQ ID NO: 36 - DNA, 60 bp, Homo sapiens
taccccaccctccaccccttccttttgcgcggaccccattacaataaattttaaataaaa

SEQ ID NO: 37 - DNA, 60 bp, Homo sapiens
actttcccatcttgtctctcttggatgatgtttgccgtcagcattcaccaaataaacttg

SEQ ID NO: 38 - DNA, 60 bp, Homo sapiens
ccaaatcaagcagtcagtttgcacaacaagatggggtgggggatattgagggagacagcg

SEQ ID NO: 39 - DNA, 60 bp, Homo sapiens
ggcgttgtgggcaggctactggtttgtatgatgtattagtagagcaacccattaatcttt

SEQ ID NO: 40 - DNA, 60 bp, Homo sapiens
ttgggaaggagacagacttattactagatgattcgctggtgtccatctttgggaatcgac

SEQ ID NO: 41 - DNA, 60 bp, Homo sapiens
atctgttggactttccacctggtcatatactctgcagctgttagaatgtgcaagcacttg

SEQ ID NO: 42 - DNA, 60 bp, Homo sapiens
cccggtttggcagtgaaggaactgaaatgaaccagacacactgattggaactgtattata

SEQ ID NO: 43 - DNA, 60 bp, Homo sapiens
accattatgcagaatccacgccagtacaagatcccagactggttcttgaacagacagaag

SEQ ID NO: 44 - DNA, 60 bp, Homo sapiens
ggtgggtgagagagacaggcagctcggattcaactaccttagataatatttctgaaaacc

SEQ ID NO: 45 - DNA, 60 bp, Homo sapiens
tgtaatttactggcatatgttttgtagactgtttaatgactggatatcttccttcaactt

SEQ ID NO: 46 - DNA, 60 bp, Homo sapiens
agaatcctagatagttttcccttcaagtcaagcgtcttgttgtttaaataaacttcttgt

SEQ ID NO: 47 - DNA, 60 bp, Homo sapiens
ccccacagtaggtgttttcacataagattagggtccttttggaaagaatagttgcagtgt

SEQ ID NO: 48 - DNA, 60 bp, Homo sapiens
agtatttgaaatttgcacatttaattgtccctaatagaaagccacctattctttgttgga

SEQ ID NO: 49 - DNA, 60 bp, Homo sapiens
caatgaaagtttgcactgtatgctggacggcattcctgcttatcaataaacctgtttgtt

SEQ ID NO: 50 - DNA, 60 bp, Homo sapiens
tgttaattcttcagtcatggcattcgcagtgcccagtgatggcattactctgcactatag

SEQ ID NO: 51 - DNA, 60 bp, Homo sapiens
gggtgtctaagtttccccttttaaggtttcaacaaatttcattgcactttcctttcaata

SEQ ID NO: 52 - DNA, 60 bp, Homo sapiens
tcttccttccgctcctttacctaccaccttccctctttctacattctcatctactcattg

(19) United States
(12) Patent Application Publication
(10) Pub. No.: US 2011/0263447 A1
(43) Pub. Date: Oct. 27, 2011

(54) METHOD FOR THE PROGNOSIS AND DIAGNOSIS OF TYPE II DIABETES IN CRITICAL PERSONS

(75) Inventors: Donat De Groote, Liege (BE); Jurgen Claesen, Liege (BE)

(73) Assignee: PROBIOX SA, Liege (BE)

(21) Appl. No.: 13/063,582

(22) PCT Filed: Sep. 14, 2009
(86) PCT No.: PCT/EP2009/061861

§ 371 Date: Apr. 15, 2011

(30) Foreign Application Priority Data
Sep. 12, 2008 (GB) 0816633.2

(51) Int. Cl. C40B 30/04; C40B 30/00

(52) U.S. Cl. 506/9; 506/7

(57) ABSTRACT

This invention is based on the characterization of a set of genes, changes in expression thereof having predictive value on the susceptibility or predisposition to type II diabetes (T2D) in critical persons, in particular in persons having a higher risk in developing T2D such as overweight, obese and pre-diabetic persons. The invention provides in vitro methods for diagnosing, prediction of clinical course, subdiagnosis (based on a Risk Score), prediction and efficacy of treatments for T2D, in critical persons. The genes, and gene products of the present invention are also useful in identifying treatment methods and agents for prevention and/or treatment of T2D onset in critical persons.

### FIELD OF THE INVENTION

This invention is based on the characterization of a set of genes, of which changes in expression having predictive value on the susceptibility or predisposition to type II diabetes (T2D) in critical persons, in particular in persons having a higher risk in developing T2D such as overweight, obese and pre-diabetic persons.

The invention provides methods for diagnosis, prediction of clinical course, subdiagnosis (based on a Risk Score), prediction and efficacy assessment of treatments for T2D, in critical persons. The genes, and gene products of the present invention are also useful in identifying treatment methods and agents for prevention and/or treatment of T2D onset in critical persons.

### BACKGROUND TO THE INVENTION

Obesity is a prevalent metabolic disorder in the developed countries and in large parts of the developing world. In 2004, the age-adjusted rate of obesity and overweight were estimated to 65.1% for the adult population and 16% for children. Among overweight adults aged 45-74, 12.5% have diagnosed diabetes, 11% have undiagnosed diabetes and 25% of them have pre-diabetes (Benjamin S M, Valdez R, Geiss L S, Rolka D B, Narayan K M. Estimated number of adults with prediabetes in the US in 2000: opportunities for prevention. Diabetes Care. 2003 March; 26(3):645-9). Pre-diabetes is a metabolic condition characterized by insulin resistance and primary or secondary beta cell dysfunction which increases the risk of developing type II diabetes. Pre-diabetes is determined by the levels of fasting plasma glucose (FPG) and/or 2-hours postload glucose. (Valensi P et al, Pre-diabetes essential action: a european perspective, diabetes Metab 2005, 31:606-620). There is a strong, graded and independent association between the body mass index (BMI) and pre-diabetes. The relative risk of pre-diabetes and/or diabetes for obese persons is 2 to 3 times higher than for non-obese persons. Approximately 30% of people with pre-diabetes will convert to type 2 diabetes within 5 years (Diabetes Prevention Program Research Group. Strategies to identify adults at high risk for type 2 diabetes: the Diabetes Prevention Program. Diabetes Care. 2005 January; 28(1):138-44).

Given the high prevalence of obesity in the world, the high incidence of pre-diabetes in obesity, the risk linked to these conditions to develop type II diabetes and the relative important level of undiagnosed diabetes in overweight persons, there is an important unmet need for new prognostic and diagnostic tests for type II diabetes.

The prognostic tests should be able to evaluate the risk of developing type II diabetes in critical persons and more particularly in overweight persons. Such predictive test does not exist today.

The diagnostic test could be an alternative or a complementary test to the actual recognized diagnostic criteria that combines symptoms of diabetes, casual plasma glucose, FPG and 2-h postload glucose.

Therefore, the objective of this study was to provide a set of genes or gene products that allow predicting the susceptibility or predisposition of a critical person for T2D.

As it was clearly demonstrated that oxidative stress is associated to obesity and could be the unifying mechanism of the development of major obesity-related comorbidities such as cardiovascular diseases, insulin resistance and type II diabetes (Vincent H K, Taylor A G. Biomarkers and potential mechanisms of obesity-induced oxidant stress in humans. Int J Obes (Lond). 2006 March; 30(3):400-18. Review), we used a DNA micro-array containing 200 genes involved in oxidative stress sensitive pathways to study differential gene expression profiles in whole blood of obese, diabetic and healthy subjects.

From said panel, we identified a set of genes that is differentially expressed in obesity and diabetes and validated a new gene profiling based diagnostic and prognostic test, that not only allows the diagnosis of type II diabetes in obese and non-obese persons, but also the prognosis of the risk of critical persons to develop type II diabetes.

### SUMMARY OF THE INVENTION

This invention is based on the observation that the set of marker genes as shown in table 3, and Table 6 allows to diagnose and predict the susceptibility of persons for T2D in a population of critical persons, i.e. persons known to have a higher risk in developing T2D.

It is accordingly a first objective of the present invention to provide an in vitro method for diagnosis or risk assessment of T2D in a critical person, said method comprising;
determining the expression level of at least 2 genes of the genes set forth in Table 3 or Table 6, in a biological sample taken from said person; and
wherein the profile of the (relative) expression levels of said genes is indicative for the diagnosis and susceptibility of said person for T2D.

In the aforementioned method and as exemplified in the examples hereinafter, a profile of expression levels that significantly differs from the profile of the (relative) expression of said genes in non-T2D critical persons, is indicative for an increased risk or the diagnosis of T2D in said person.

In a further embodiment, the method further comprises the step of comparing the expression level of said genes with the expression level(s) observed in non-T2D control(s). For example, by comparing the expression level of said genes with the expression levels observed in a sample taken from a non-T2D control. These ‘control’ expression levels typically consist of the mean expression levels of said genes as determined in a representative set of samples taken from non-T2D controls; preferably said ‘control’ levels are predetermined, i.e. independent from the ‘patient’ (critical person) sample.

Thus in a particular embodiment, the in vitro method comprises the step of comparing the expression level of said genes with the predetermined (pre-established) mean expression level observed in a representative set of samples taken from non-T2D controls.

As provided in more detail in the examples hereinafter, in one embodiment, the in vitro methods of the present invention comprises determining the expression levels of at least 5, 6, 7, 8, 9, 10, 11, 12 or 13 genes of the genes set forth in Table 3 or Table 6.

In an even further embodiment the genes as used in the aforementioned methods, are selected from the group of genes set forth in Table 8, Table 11 or Table 12 hereinafter. The expression level of the T2D marker genes of the present invention, can be assessed;
at the nucleic acid level; or
as an expression product of said genes, such as at the mRNA level or protein level.

The expression levels can be obtained for example by Northern blot analysis, Western blot analysis, immunohistochemistry, in situ hybridization or other methods known in the art such as for example described in Sambrook et al. (Molecular Cloning; A laboratory Manual, Second Edition, Cold Spring Harbour Laboratory Press, Cold Spring Harbour N.Y. (1989)) or in Schena (Science 270 (1995) 467-470).

Most preferably the expression levels of the T2D genes are determined at the mRNA level using microarrays as e.g. described in the examples hereinafter, and accordingly in an even further embodiment, the expression levels of the T2D genes is determined by an array of oligonucleotide probes specific for the T2D genes of the present invention.

As will be evident to the skilled artisan, the aforementioned diagnostic methods can also be applied in monitoring T2D progression in a critical person, i.e. in applying the aforementioned diagnostic methods on a series of at least two consecutive samples taken from said person and wherein a change in expression levels of the T2D genes of the present invention into expression levels similar to the expression levels of said genes in a representative set of non-T2D controls, is indicative for a positive disease progression.

As already mentioned hereinbefore, using the methods of the present invention one may identify treatment methods and agents for prevention and/or treatment of T2D onset in critical persons. Hence, in a second objective, the present invention provides an assay to determine whether an agent or method of treatment is able to prevent or reduce the onset of T2D in a critical person, said method comprising;
determining the expression level of at least 2 genes of the genes set forth in Table 3 or Table 6, in a biological sample taken from said person, in the presence and absence of the agent or method of treatment to be tested; and
wherein an agent or method of treatment capable to modify the expression levels of said genes into expression levels similar to the expression levels of said genes in a representative set of non-T2D controls, is indicative for an agent or method of treatment capable to prevent or reduce the onset of T2D in a critical person.

As for the in vitro diagnostic methods (supra),
the screening method optionally comprises the step of comparing the expression level of said genes with the pre-established mean expression levels observed in a representative set of samples taken from non-T2D control
the screening methods are in particular selected from the group of genes set forth in Table 3 or Table 6 hereinafter, and in a more particular embodiment consists of the set of genes set forth in Table 8, Table 11 or Table 12 below.

Again, the expression levels can be assessed; at the nucleic acid level; or as an expression product of said genes, such as at the mRNA level or protein level. In a particular embodiment the screening method is performed by an array of oligonucleotide probes specific for the T2D genes of the present invention.

The isolated biological sample as used in the in vitro methods of the present invention can be any biological sample from a human, e.g., whole blood, serum blood, saliva, plasma, synovial fluids, sweat, urine, isolated blood cells etc. . . . ; but in particular consist of a whole blood, serum or plasma sample; more in particular a whole blood sample.

The methods of the present invention optionally comprise a step of calculating the risk of T2D in said critical person, as the cumulative value of the DTCO (Distance To Cut Off) of each of the genes assessed in the aforementioned methods, i.e. R (Risk)=□ DTCO, and wherein an increase in R is indicative for an increased risk in developing T2D. In the present case the cut off values are defined as following:
For the genes of the present invention that are over expressed in diabetic critical persons compared to healthy controls, the cut offs are the upper limit values for which 100% of the individual log 2 fold changes of a validated set of non-diabetic critical persons vis-à-vis the mean expression levels of said genes in a comparable set of healthy controls are inferior to the said upper limit.
For the genes of the present invention that are under expressed in diabetic critical persons compared to healthy controls, the cut offs are the lower limit values for which 100% of the individual log 2 fold changes of a validated set of non-diabetic critical persons vis-à-vis the mean expression levels of said genes in a comparable set of healthy controls are superior to the said lower limit.

The DTCO for a given gene is then calculated as follows; for genes that are up-regulated in diabetes, DTCO=log 2FC−cut off and for genes that are down-regulated in diabetes, DTCO=−(log 2FC−cut off).

In a further embodiment the risk is scored on an incremental scale from 0 to 10; wherein

Risk level 0: □ DTCO=0
Risk level 1: □ DTCO>0 up to 2
Risk level 2: □ DTCO>2 up to 4
Risk level 3: □ DTCO>4 up to 6
Risk level 4: □ DTCO>6 up to 8
Risk level 5: □ DTCO>8

Based on the aforementioned cut off values, in a particular embodiment of the present invention, the methods comprise determining the expression levels of the genes selected from Table 3 or Table 6 having a specificity of 100% and a sensitivity of at least 80%, in particular at least 83%, more in particular at least 86% when compared to the expression level of said genes in a non-T2D control group. In an even further embodiment the methods comprise determining the expression levels of 8, 9, 10, 11, 12 or 13 genes selected from Table 8, said genes having a specificity of 100% and a sensitivity of at least 86% when compared to the expression level of said genes in a non-T2D control group.

In a preferred embodiment the methods comprise;
determining the expression levels of the genes shown in Table 8, i.e. consisting of CRP, ARF1, EIF4G2, HSPCB, CFL1, TNFRSF1B, UBC, UCP2, CCR7, HSPA1A, IL2RG, MAZ and MYL6, in particular consisting of CRP, ARF1, EIF4G2, HSPCB, CFL1, TNFRSF1B, UBC, and UCP2; in a biological sample taken from said person;
calculating the risk of T2D in said critical person, as the cumulative value of the DTCO (Distance To Cut Off) of each of said genes; and wherein
Risk level 0: □ DTCO=0
Risk level 1: □ DTCO>0 up to 2
Risk level 2: □ DTCO>2 up to 4
Risk level 3: □ DTCO>4 up to 6
Risk level 4: □ DTCO>6 up to 8
Risk level 5: □ DTCO>8

In said embodiments of the present invention wherein the expression levels of the T2D genes as provided herein, are used in an in vitro assay to diagnose T2D in a critical person, said genes are in particular selected from the genes shown in Tables 11 and 12. In said embodiments the genes shown in Table 11 are in particular useful to discriminate and diagnose Diabetic non-obese over non-obese Healthy individuals. The genes shown in Table 12 are in particular useful to discriminate and diagnose Diabetic Obese over Obese non-diabetic individuals.

It is thus an embodiments the present invention to provide an in vitro method to discriminate Diabetic non-obese over non-obese Healthy individuals, said method comprising;
determining the expression levels of the genes shown in Table 11, i.e. consisting of SMT3H2, SRP14, CD3D, FOS, IL2, ICAM3, IL3, COX7C, EIF4G2, FTH1, and RSP18; in a biological sample taken from said person;
calculating the risk of T2D in said person, as the cumulative value of log 2FC of each said up-regulated genes minus the cumulative value of log 2FC of each said down regulated gene (DIASCORE); and wherein DIASCORE>8 identifies T2D in non-obese individuals.

Analogously and in a further embodiment, the present invention provides an in vitro method to discriminate Diabetic Obese over Obese non-diabetic individuals, said method comprising;
determining the expression levels of the genes shown in Table 12, i.e. consisting of IL2RG, RPL13A, LTF, EIF4G2, OGG1, HMOX1, CRF, HSPA5, CD3D, IL2RB and CCR7; in a biological sample taken from said person;
Calculating the risk of T2D in said person, as the cumulative value of log 2FC of each said up-regulated genes minus the cumulative value of log 2FC of each said down regulated gene (DIASCORE_OB); and wherein DIASCORE_OB>4.5 identifies T2D in obese individuals.

### BRIEF DESCRIPTION OF THE DRAWINGS

FIG. 1: Expression profile of the 43 genes in the comparisons of; the obese (O) group was compared to the healthy donors (H) group (O/H) and the obese diabetics (OD) group was compared to the H group (OD/H) and to the O Group (OD/O).

FIG. 2: Cluster Dendrogram after Ward's clustering with the complete set of genes.

FIG. 3: Cluster Dendrogram after Ward's clustering with the subset of genes.

FIG. 4: Graphical representation of the □ DTCO of the 34 genes as well as by a score scale of 12 different patients.

### DESCRIPTION OF THE INVENTION

The methods and assays of the present invention are based on the validation of a set of genes as markers for type 2 diabetes (T2D) in a population of critical persons. The subpopulation of critical persons as used herein, refers to people with an increased risk in developing T2D based on the presence of one or more of the commonly known risk factors associated with diabetes. The more risk factors an individual has, the greater his/her likelihood of developing type 2 diabetes.

The risk factors identified for T2D include; overweight (apple shaped figure), obesity, pre-diabetic (impaired glucose tolerance), gestational diabetes, high blood pressure, and high cholesterol or other fats in the blood.

### Obesity

An excessively high body weight increases diabetes risk. The Body Mass Index (BMI) is a simple, widely accepted means of assessing body weight in relation to health for most people aged 20 to 65 (Exceptions include people who are very muscular, athletes, pregnant or nursing.) A BMI greater than 27 indicates a risk for developing type 2 diabetes, and other health problems which include cardiovascular disease, and premature death. As the implications of the BMI are not the same for everyone, one should discuss his/her BMI with his/her physician if it is too high (or too low) according to the chart.

Overweight Associated with an Apple-Shaped Figure

Individuals who carry most of their weight in the trunk of their bodies (i.e., above the hips) tend to have a higher risk of diabetes than those of similar weight with a pear-shaped body (excess fat carried mainly in the hips and thighs). A waist measurement of more than 100 cm (39.5 inches) in men and 95 cm (37.5 inches) in women suggests an increased risk.

### Gestational Diabetes

Nearly 40 percent of the women who have diabetes during their pregnancy go on to develop type 2 diabetes later, usually within five to ten years of giving birth. Giving birth to a baby that weighs more than nine pounds (4 kg) is another symptom of gestational diabetes.

### Impaired Glucose Tolerance

Impaired glucose tolerance or impaired fasting glucose can precede the development of type 2 diabetes. These conditions are determined through blood tests. While persons affected with these problems do not meet the diagnostic criteria for diabetes, their blood sugar control and reaction to sugar loads are considered to be abnormal. This places them at higher risk, not just for the development of type 2 diabetes (an estimated one in ten progress to type 2 diabetes within five years), but also for cardiovascular disease. For this group, preventive strategies—including lifestyle changes and regular screening for diabetes mellitus—must be a priority.

### High Blood Pressure

Up to 60 percent of people with undiagnosed diabetes have high blood pressure.

### High Cholesterol or Other Fats in the Blood

More than 40 percent of people with diabetes have abnormal levels of cholesterol and similar fatty substances that circulate in the blood. These abnormalities appear to be associated with an increased risk of cardiovascular disease among persons with diabetes.

The T2D marker genes of the present invention are particularly useful in diagnosing and predicting the susceptibility of critical persons in developing T2D, and accordingly in the methods of the present invention the critical person consists of a person having one or more of the risk factors identified for T2D and selected from the group consisting of overweight (apple shaped figure), obesity, pre-diabetic (impaired glucose tolerance), gestational diabetes, high blood pressure, and high cholesterol or other fats in the blood.

It is accordingly an objective of the present invention to provide an in vitro method for diagnosis or risk assessment of T2D in a critical person, wherein said critical person consists of a person having one or more of the risk factors identified for T2D and selected from the group consisting of overweight (apple shaped figure), obesity, pre-diabetic (impaired glucose tolerance), gestational diabetes, high blood pressure, and high cholesterol or other fats in the blood; said method comprising;
determining the expression level of at least 2 genes of the genes set forth in Table 3 or Table 6, in a biological sample taken from said person; and
wherein the profile of the (relative) expression levels of said genes is indicative for the diagnosis and susceptibility of said person for T2D.

In a more particular embodiment the critical person is an obese person.

It is thus a further objective of the present invention to provide a method for diagnosis or risk assessment of T2D in an obese person, said method comprising;
determining the expression level of at least 2 genes of the genes set forth in Table 3 or Table 6, in a biological sample taken from said person; and
wherein the profile of the (relative) expression levels of said genes is indicative for the diagnosis and susceptibility of said person for T2D.

The expression profile of the T2D genes of the present invention as used herein, refers to a differential or altered gene expression of the genes identified in Table 3 or Table 6 hereinafter and can be measured by changes in the detectable amount of gene expression products such as cDNA or mRNA or by changes in the detectable amount of proteins expressed by those genes.

The pattern of high and/or low expression of as few as two of the defined set of T2D genes provides a profile that can be linked to a particular stage of T2D progression, or to any other distinct or identifiable condition that influences T2D gene expression in a predictable way (e.g., glucose intolerance, pre-diabetic), in a population of critical persons. In other particular examples, the expression profile is determined in at least 5, 6, 7, 8, 9, 10, 11, 12 or 13 of the T2D genes listed in Table 3 or Table 6. In a further example the at least 13 genes consist of the genes listed in Table 8, i.e. CRP, ARF1, EIF4G2, HSPCB, TNFRSF1B, UBC, CFL1, UCP2, CCR7, HSPA1A, IL2RG, MAZ, and MYL6. In another embodiment the genes consist of the genes listed in Table 11 or of the genes listed in Table 12.

Gene expression profiles can include relative as well as absolute expression levels of the T2D genes, and can be viewed in the context of a test sample compared to a baseline or control sample profile (such as a sample from a subject, in particular a critical person, who does not have T2D). The latter can be predetermined as the mean expression levels of the T2D genes in a representative set of samples taken from non-T2D controls.

In one example, the gene expression profile in a subject is read on an array (such as a nucleic acid or protein array). For example, a gene expression profile is performed by an array of oligonucleotide probes specific for the T2D genes of the present invention, such as for example shown in Table 3, or using a commercially available array such as a Human Genome U133 2.0 Plus oligonucleotide Microarray from AFFYMETRIX(R) (AFFYMETRIX(R), Santa Clara, Calif.).

As an alternative or in addition to detecting nucleic acids, proteins can be detected, using routine methods such as Western blot or mass spectrometry. In some examples, proteins are purified before detection. In one example, T2D sensitivity-related proteins can be detected by incubating the biological sample with an antibody that specifically binds to one or more of the disclosed T2D sensitivity-related proteins encoded by the genes listed in Table 6, Table 8, Table 10, Table 11 or Table 12. The primary antibody can include a detectable label. For example, the primary antibody can be directly labeled, or the sample can be subsequently incubated with a secondary antibody that is labeled (for example with a fluorescent label). The label can then be detected, for example by microscopy, ELISA, flow cytometery, or spectrophotometry. In another example, the biological sample is analyzed by Western blotting for the presence of at least one of the disclosed T2D sensitivity-related molecules (see Tables 6 and in particular Tables 8, 11 or 12).

As previously described, the T2D genes can be used in methods of identifying agents and methods of treatments that modulate the T2D expression profiles in a subject. Generally, such methods involve contacting (directly or indirectly) said subject with a test agent or a method of treatment, and detecting a change (e.g., a decrease or increase) in the expression profile of the T2D sensitivity-related genes.

“Test agent” as used herein include, but is not limited to, siRNAs, peptides such as for example, soluble peptides, including but not limited to members of random peptide libraries (see, e.g., Lam et al, Nature, 354:82-84, 1991; Houghten et al, Nature, 354:84-86, 1991), and combinatorial chemistry-derived molecular library made of D- and/or L-configuration amino acids, phosphopeptides (including, but not limited to, members of random or partially degenerate, directed phosphopeptide libraries; see, e.g., Songyang et al, Cell, 72:767-778, 1993), antibodies (including, but not limited to, polyclonal, monoclonal, humanized, anti-idiotypic, chimeric or single chain antibodies, and Fab, F(ab′)2 and Fab expression library fragments, and epitope-binding fragments thereof), and small organic or inorganic molecules (such as so-called natural products or members of chemical combinatorial libraries).

In an alternative embodiment of the aforementioned screening methods, the modulation of the expression of the T2D sensitivity-related genes or gene products (e.g., transcript or protein) can be determined using any expression system capable of expressing said T2D polypeptides or transcripts (such as a cell, tissue, or organism, or in vitro transcription or translation systems). In some embodiments, cell-based assays are performed. Non-limiting exemplary cell-based assays may involve test cells such as cells (including cell lines) that normally express the T2D genes of the present invention, or cells (including cell lines) that have been transiently transfected or stably transformed with expression vectors encoding for the T2D gene products of the present invention. A difference in T2D expression profiles in said cells in the presence or absence of a test agent indicates that the test agent modulates the T2D expression profiles in said cells.

In the context of the present invention, methods of treatment are not limited to the administration of a therapeutically effective amount of an agent to a subject in need thereof, but also includes dietary control, physical training programs, etc.

A further aspect of the present invention relates to the use of the aforementioned expression profiles in calculating the risk of T2D development in said critical person. As provided in more detail in the examples hereinafter, the risk of T2D in said critical person is calculated as the cumulative value of the DTCO (Distance To Cut Off) of each the genes assessed in the aforementioned methods, i.e. R (Risk)=□ DTCO, and wherein an increase in R is indicative for an increased risk in developing T2D. In the present case the cut off values are defined as follows:
For the genes of the present invention that are over expressed in diabetic critical persons compared to healthy controls, the cut offs are the upper limit values for which 100% of the individual log 2 fold changes of a validated set of non-diabetic critical persons vis-à-vis the mean expression levels of said genes in a comparable set of healthy controls are inferior to the said upper limit.
For the genes of the present invention that are under expressed in diabetic critical persons compared to healthy controls, the cut offs are the lower limit values for which 100% of the individual log 2 fold changes of a validated set of non-diabetic critical persons vis-à-vis the mean expression levels of said genes in a comparable set of healthy controls are superior to the said lower limit.

The DTCO for a given gene is then calculated as follows; for genes that are upregulated in diabetes, DTCO=log 2FC−cut off and for genes that are downregulated in diabetes, DTCO=−(log 2FC−cut off).

In a further embodiment the risk is scored on an incremental scale from 0 to 10; wherein

Risk level 0: □ DTCO=0
Risk level 1: □ DTCO>0 up to 2
Risk level 2: □ DTCO>2 up to 4
Risk level 3: □ DTCO>4 up to 6
Risk level 4: □ DTCO>6 up to 8
Risk level 5: □ DTCO>8

Based on the aforementioned cut off values, in a particular embodiment of the present invention, the methods comprise determining the expression levels of the genes selected from Table 6 having a specificity of 100% and a sensitivity of at least 80%, in particular at least 83%, more in particular at least 86% when compared to the expression level of said genes in a non-T2D control group.

The specificity of a gene of the present invention is defined as the percentage of the non-diabetic critical persons from the validated set of non-diabetic critical persons whose log 2 FC for the said gene vis-à-vis the mean expression levels of said gene in a comparable validated set of healthy controls is inferior to the aforementioned upper limit cut off or superior to the aforementioned lower limit cut off.

The sensitivity of a gene of the present invention is defined as the percentage of the diabetic critical persons from the validated set of diabetic critical persons whose log 2 FC for the said gene vis-à-vis the mean expression levels of said gene in a comparable validated set of healthy controls is superior to the aforementioned upper limit cut off or inferior to the aforementioned lower limit cut off.

Where applied to the T2D gene profiles of the present invention, it will be apparent to the skilled artisan that the present method of determining the risk factor for T2D in a subpopulation of critical persons can analogously be applied to gene profiling data of other sample sets. It is thus a further objective of the present invention to provide a method of determining the risk factor for a subject in developing a certain indication, i.e. in being correctly classified in a predefined group.

In said methodology one starts from a validated set of genes, i.e. a set of genes for which the expression profile is linked to said predefined group. The predefined group can be linked to a tissue or cell type, to a particular stage of normal tissue growth or disease progression (such as T2D progression in a subpopulation of critical persons), or to any other distinct or identifiable condition that influences gene expression in a predictable way (e.g. glucose intolerance, pre-diabetic).

Subsequently, for each of said genes the cut-off values are determined based on a comparison of the expression of said genes in a validated set of representative samples of said predefined group vis-à-vis the mean expression levels of said genes in a comparable set of controls.
For the genes that are over-expressed in the predefined group compared to the control group, the cut offs are the upper limit values for which 100% of the individual log 2 fold changes of the genes in this predefined group vis-à-vis the mean expression levels of said genes in a comparable set of controls are inferior to the said upper limit.
For the genes that are under-expressed in the predefined group compared to the control group, the cut offs are the lower limit values for which 100% of the individual log 2 fold changes of the genes in this predefined group vis-à-vis the mean expression levels of said genes in a comparable set of controls are superior to the said lower limit.

Once the cut off values are determined, one determines the DTCO for each said genes in a sample taken from a subject susceptible of being a member of said predefined group, wherein the DTCO for genes that are upregulated=log 2FC of said gene−cut off and for genes that are downregulated, DTCO=−(log 2FC of said gene−cut off).

And, as for the T2D group above, the cumulative value of the DTCO's is indicative for the distance of said patient vis-à-vis the predefined group, wherein a low value, i.e. close to zero is an indication that the subject is close (belongs) to the predefined group. Again, as for the risk factor above, the cumulative index can be scored on an incremental scale from 0 to 10.

A further aspect of the present invention relates to the use of the aforementioned expression profiles in calculating the risk of T2D in non-obese (DIASCORE) or obese (DIASCORE_OB) subjects. As provided in more detail in the examples hereinafter, the risk of T2D in said critical person is calculated as the cumulative value of log 2FC of each said up-regulated genes minus the cumulative value of log 2FC of each said down regulated gene and wherein DIASCORE>8 identifies T2D in non-obese individuals and DIASCORE_OB>4.5 identifies T2D in obese individuals.

This invention will be better understood by reference to the Experimental Details that follow, but those skilled in the art will readily appreciate that these are only illustrative of the invention as described more fully in the claims that follow thereafter. Additionally, throughout this application, various publications are cited. The disclosure of these publications is hereby incorporated by reference into this application to describe more fully the state of the art to which this invention pertains.

### EXAMPLES

The following examples illustrate the invention. Other embodiments will occur to the person skilled in the art in light of these examples.

### Example 1

### Subjects

Diabetic patients and obese patients were recruited at the consultations of diabetology (University hospital of Liege, Belgium) and gastrology (ERASME hospital, Brussels, Belgium). Healthy volunteers were recruited by poster campaign. The study was approved by the Ethics Committees of the University hospital of Liege and ERASME hospital of Brussels and informed consent was obtained from the subjects. The characteristics of the patients are shown in table 1

TABLE 1
Patients and healthy volunteer's characteristics

| | Non-Diabetic | Diabetic | Healthy |
|---|---|---|---|
| Characteristics | Obese | Obese | donors |
| Male | 11 | 9 | 10 |
| Female | 25 | 17 | 12 |
| Contraception (pill) | 9 | 3 | 0 |
| Smokers | 8 | 6 | 7 |
| Average BMI | 39.8 | 38.4 | 23.3 |
| Average age | 38.17 yrs | 57.6 yrs | 41.3 yrs |
| Total | 36 | 26 | 22 |

TABLE 2
subset of patients for the gene by gene analysis
after removal of outliers

| Healthy | Non Diabetic Obese | Diabetic Obese |
|---|---|---|
| BMI 20-25 | BMI 30- . . . | BMI 30- . . . |
| No Pill | No Pill | No Pill |
| No menopauze | No menopauze | No menopauze |
| No chronic illness | No chronic illness | Diabetic Type II |
| | except HTA | some HTA |
| No medication | No or HTA related | Diabetes and/or |
| | | HTA related |
| 18 Patients | 14 Patients | 21 Patients |

### Microarray

The oligonucleotide probes of 60 bases (60-mer) were deposited by a robot on chemically pre-treated glass slides. To realize the test, whole blood samples were collected on PackGene™ tubes and mRNA were purified with the QIAamp RNA Blood Mini Kit from Qiagen. A reverse transcription in the presence of probes containing the Genisphere 3DNATM capture sequence was then realized. The resulting cDNAs were then hybridized on the micro-array. The presence of the sample cDNAs were then detected by complementary 3DNATM Capture Reagents that were Cy3 labeled. The acquisition and the analysis of the images were realized by means of a scanner GenePix and of the software GenePix Pro 5.0. (Axon Instruments). All values derived from the image analysis were background corrected and normalised by the variance stabilization method of Huber et al. (Huber W., Von Heydebreck, A., Sultmann, H., Poustka, A. and Vingron, M. (2002) Variance stabilization applied to microarray data calibration and to the quantification of differential expression (Bioinformatics, 18: S96-S104), against a common reference slide. After normalisation, outlier slides were detected and removed when their Pearson correlation coefficient was in average lower than 70%. A pool of mRNA was used as standard control.

### Oligonucleotides

The oligonucleotides used in the microarray of the present example and the genes elected for their ability in diagnosing and predicting the susceptibility or predisposition of a critical person for T2D are shown in table 3

TABLE 3

| Official | Other | | | SEQ |
|---|---|---|---|---|
| Symbol | Designations | RefSeq | Probe Sequence | ID N^{o} |
| ARF1 | ADP-ribosylation | NM_001658 | ATTTATCTTGGGGAAACCTCAG | 1 |
| | factor 1 | | AACTGGTCTATTTGGTGTCGTG | |
| | | | GAACCTCTTACTGCTT | |
| CAPZB | capping protein (actin | NM_004930 | AAAGAGAGAAGAAAAACTGGAA | 2 |
| | filament) muscle | | ATCTTATTCCGTGTGTGTTTGG | |
| | Z-line, beta | | GAGTTGCTTGGGGTTG | |
| CAT | catalase | NMO01752 | AATACAGCAGTGTCATCAGAAG | 3 |
| | | | ATAACTTGAGCACCGTCATGGC | |
| | | | TTAATGTTTATTCCTG | |
| CCR2 | chemokine (CC motif) | NM_000648 | GGAGAGTTTGGGAACTGCAAT | 4 |
| | receptor 2 | | AACCTGGGAGTTTTGGTGGAG | |
| | | | TCCGATGATTCTCTTTTG | |
| CCR7 | chemokine (CC motif) | NM_001838 | TCTTTGTTCTTTGTCACAGGGA | 5 |
| | receptor 7 | | CTGAAAACCTCTCCTCATGTTC | |
| | | | TGCTTTCGATTCGTTA | |
| CD14 | CD14 antigen | NM_000591 | GGCTTTGCCTAAGATCCAAGAC | 6 |
| | | | AGAATAATGAATGGACTCAAAC | |
| | | | TGCCTTGGCTTCAGGG | |
| CD3D | CD3D antigen, delta | NM_000732 | TCTAGAAGCAGCCATTACCAAC | 7 |
| | polypeptide | | TGTACCTTCCCTTCTTGCTCAG | |
| | (TiT3 complex) | | CCAATAAATATATCCT | |
| CFL1 | cofilin 1 (non-muscle) | NM_005507 | TGCTGCCAACTTCTAACCGCAA | 8 |
| | | | TAGTGACTCTGTGCTTGTCTGT | |
| | | | TTAGTTCTGTGTATAA | |
| COX7C | cytochrome c oxidase | NM_001867 | AGGTGCAGCCTCTGGAAGTGG | 9 |
| | subunit VIIc | | ATCAAACTAGAACTCATATGCC | |
| | | | ATACTAGATATGTTTGT | |
| CRF | C 1q-related factor | NM_006688 | CTATATATTTGTACAATAGGACT | 10 |
| | | | GTTTACTGCCCACCTCCGCCTG | |
| | | | CCAGCCCACCCCAGC | |
| CRF | C 1q-related factor | NM_006688 | CTATATATTTGTACAATAGGACT | 11 |
| | | | GTTTACTGCCCACCTCCGCCTG | |
| | | | CCAGCCCACCCCAGC | |
| CRP | Creactive protein, | X56692 | TTGTTTGCTTGCAGTGCTTTCT | 12 |
| | pentraxinrelated | | TAATTTTATGGCTCTTCTGGGA | |
| | | | AACTCCTCCCCTTTTC | |
| CXCR4 | chemokine (CXC motif) | NM_003467 | TCAGTTTTCAGGAGTGGGTTGA | 13 |
| | receptor 4 | | TTTCAGCACCTACAGTGTACAG | |
| | | | TCTTGTATTAAGTTGT | |
| DDIT3 | DNAdamageinducible | S40706 | CAATCCCACATACGCAGGGGG | 14 |
| | transcript 3 | | AAGGCTTGGAGTAGACAAAAG | |
| | | | GAAAGGTCTCAGCTTGTA | |
| EIF4A2 | eukaryotic translation | NM_001967 | TTATTCAATAAAGTATTTAATTA | 15 |
| | initiarion factor 4A, | | GTGCTAAGTGTGAACTGGACC | |
| | isoform 2 | | CTGTTGCTAAGCCCCA | |
| EIF4G2 | eukaryotic translation | NM_001418 | TTGTGGGTGTGAAACAAATGGT | 16 |
| | initiarion factor 4 | | GAGAATTTGAATTGGTCCCTCC | |
| | gamma, 2 | | TATTATAGTATTGAAA | |
| ELA2 | elastase 2, neutrophil | M34379 | CCCGGTGGCACAGTTTGTAAA | 17 |
| | | | CTGGATCGACTCTATCATCCAA | |
| | | | CGCTCCGAGGACAACCC | |
| FOS | vfos FBJ murine | NM_005252 | ATGTTCATTGTAATGTTACTGA | 18 |
| | osteosarcoma viral | | TCATGCATTGTTGAGGTGGTCT | |
| | oncogene homolog | | GAATGTTCTGACATT | |
| FTH1 | ferritin, heavy | NM002032 | CGGAATATCTCTTTGACAAGCA | 19 |
| | polypeptide 1 | | CACCTGGGAGACAGTGATAAT | |
| | | | GAAAGCTAAGCCTCGGG | |
| GLRX | glutaredoxin | AF069668 | TAGACTACCAGCAAAGATTAAA | 20 |
| | (thioltransferase) | | GCATGAAATGTAAAACATCTGA | |
| | | | TAAAACTTACAGCCCC | |
| GNB2 | guanine nucleotide | NM_005273 | GGCAGGAGGTGGAAACCCCAG | 21 |
| | binding protein | | GGGCTGGCTTTTTTAAAACTGG | |
| | (G protein), beta | | TTTTATTTTAATTTTTA | |
| | polypeptide 2 | | | |
| GPX1 | glutathione | M21304 | GGTCCTGTTGATCCCAGTCTCT | 22 |
| | peroxidase 1 | | GCCAGACCAAGGCGAGTTTCC | |
| | | | CCACTAATAAAGTGCCG | |
| GSTP1 | glutathione | NM000852 | ACCAGATCTCCTTCGCTGACTA | 23 |
| | Stransferase pi | | CAACCTGCTGGACTTGCTGCT | |
| | | | GATCCATGAGGTCCTAG | |
| HMOX1 | heme oxygenase | NM002133 | GCAGTATTTTTGTTGTGTTCTG | 24 |
| | (decycling) 1 | | TTGTTTTTATAGCAGGGTTGGG | |
| | | | GTGGTTTTTGAGCCAT | |
| HNRPK | heterogeneous | NM_002140 | TTCCTGTGGATGTTTTGTGTAG | 25 |
| | nuclear | | TATCTTGGCATTTGTATTGATA | |
| | ribonucleoprotein K | | GTTAAAATTCACTTCC | |
| HSPA1A | heat shock 70 kDa | M11717 | GGAGCTTCAAGACTTTGCATTT | 26 |
| | protein 1A | | CCTAGTATTTCTGTTTGTCAGTT | |
| | | | CTCAATTTCCTGTGT | |
| HSPA5 | heat shock 70 kDa | AF216292 | TTGGAAAGCTATGCCTATTCTC | 27 |
| | protein 5 | | TAAAGAATCAGATTGGAGATAA | |
| | (glucoseregulated | | AGAAAAGCTGGGAGGT | |
| | protein, 78 kDa) | | | |
| HSPCB | heat shock 90 kDa | M16660 | GCCCCATTCCCTCTCTACTCTT | 28 |
| | protein1, beta | | GACAGCAGGATTGGATGTTGT | |
| | | | GTATTGTGGTTTATTTT | |
| ICAM3 | intercellular adhesion | NM_002162 | CTTAATGTACGTCTTCAGGGAG | 29 |
| | molecule 3 | | CACCAACGGAGCGGCAGTTAC | |
| | | | CATGTTAGGGAGGAGAG | |
| IL11 | interleukin 11 | NM_000641 | CCAGGTCAAAGGAGAGAGGTG | 30 |
| | | | GGATTGTGGGTGACTTTTAATG | |
| | | | TGTATGATTGTCTGTAT | |
| IL2 | interleukin 2 | U25676 | AACAGATGGATTACCTTTTGTC | 31 |
| | | | AAAGCATCATCTCAACACTAAC | |
| | | | TTGATAATTAAGTGCT | |
| IL2RB | interleukin 2 receptor, | NM_000878 | CTGAATTATTGGACAGTCTCAC | 32 |
| | beta | | CTCCTGCCATAGGGTCCTGAAT | |
| | | | GTTTCAGACCACAAGG | |
| IL2RG | interleukin 2 receptor, | NM_000206 | ATTCAACCCACCTGCGTCTCAT | 33 |
| | gamma | | ACTCACCTCACCCCACTGTGG | |
| | | | CTGATTTGGAATTTTGT | |
| IL3 | interleukin 3 | M14743 | TTAATTATCTAATTTCTGAAATG | 34 |
| | (colonystimulating | | TGCAGCTCCCATTTGGCCTTGT | |
| | factor, multiple) | | GCGGTTGTGTTCTCA | |
| IL5 | interleukin 5 | NM_000879 | TGTAATGAACACCGAGTGGATA | 35 |
| | (colonystimulating | | ATAGAAAGTTGAGACTAAACTG | |
| | factor, eosinophil) | | GTTTGTTGCAGCCAAA | |
| LTF | lactotransferrin | M93150 | GCCCATCCATCTGCTTACAATT | 36 |
| | | | CCCTGCTGTCGTCTTAGCAAGA | |
| | | | AGTAAAATGAGAAATT | |
| MAZ | MYC-associated zinc | NM_002383 | TACCCCACCCTCCACCCCTTCC | 37 |
| | finger protein | | TTTTGCGCGGACCCCATTACAA | |
| | (purine-binding | | TAAATTTTAAATAAAA | |
| | transcription factor) | | | |
| MYL6 | myosin, light | NM_021019 | ACTTTCCCATCTTGTCTCTCTT | 38 |
| | polypeptide 6, alkali, | | GGATGATGTTTGCCGTCAGCAT | |
| | smooth muscle and | | TCACCAAATAAACTTG | |
| | non-muscle | | | |
| OGG1 | 8oxoguanine DNA | U88527 | CCAAATCAAGCAGTCAGTTTGC | 39 |
| | glycosylase | | ACAACAAGATGGGGTGGGGGA | |
| | | | TATTGAGGGAGACAGCG | |
| PRDX1 | peroxiredoxin 1 | NM002574 | GGCGTTGTGGGCAGGCTACTG | 40 |
| | | | GTTTGTATGATGTATTAGTAGA | |
| | | | GCAACCCATTAATCTTT | |
| PRDX5 | peroxiredoxin 5 | AF197952 | TTGGGAAGGAGACAGACTTATT | 41 |
| | | | ACTAGATGATTCGCTGGTGTCC | |
| | | | ATCTTTGGGAATCGAC | |
| RPL13A | Ribosomal protein | NM_012423 | ATCTGTTGGACTTTCCACCTGG | 42 |
| | L13a | | TCATATACTCTGCAGCTGTTAG | |
| | | | AATGTGCAAGCACTTG | |
| RPL38 | ribosomal proetin L38 | NM_000999 | CCCGGTTTGGCAGTGAAGGAA | 43 |
| | | | CTGAAATGAACCAGACACACTG | |
| | | | ATTGGAACTGTATTATA | |
| RPS18 | ribosomal protein S18 | NM_022551 | ACCATTATGCAGAATCCACGCC | 44 |
| | | | AGTACAAGATCCCAGACTGGTT | |
| | | | CTTGAACAGACAGAAG | |
| SERPINE1 | serpin peptidase | M16006 | GGTGGGTGAGAGAGACAGGCA | 45 |
| | inhibitor, clade E | | GCTCGGATTCAACTACCTTAGA | |
| | (nexin, plasminogen | | TAATATTTCTGAAAACC | |
| | activator inhibitor | | | |
| | type 1), member 1 | | | |
| SIRT1 | sirtuin (silent mating | AF083106 | TGTAATTTACTGGCATATGTTTT | 46 |
| | type information | | GTAGACTGTTTAATGACTGGAT | |
| | regulation 2 homolog) | | ATCTTCCTTCAACTT | |
| | 1 (S. cerevisiae) | | | |
| SMT3H2 | SMT3 suppressor of | NM_006937 | AGAATCCTAGATAGTTTTCCCT | 47 |
| | mif two 3 homolog 2 | | TCAAGTCAAGCGTCTTGTTGTT | |
| | (yeast) | | TAAATAAACTTCTTGT | |
| SRP14 | signal recognition | NM_003134 | CCCCACAGTAGGTGTTTTCACA | 48 |
| | particle 14 kDa | | TAAGATTAGGGTCCTTTTGGAA | |
| | (homologous Alu RNA | | AGAATAGTTGCAGTGT | |
| | binding protein) | | | |
| SRP14 | signal recognition | NM_003134 | CCCCACAGTAGGTGTTTTCACA | 49 |
| | particle 14 kDa | | TAAGATTAGGGTCCTTTTGGAA | |
| | (homologous Alu RNA | | AGAATAGTTGCAGTGT | |
| | binding protein) | | | |
| TNFAIP3 | tumor necrosis factor, | NM59465 | AGTATTTGAAATTTGCACATTTA | 50 |
| | alphainduced protein | | ATTGTCCCTAATAGAAAGCCAC | |
| | 3 | | CTATTCTTTGTTGGA | |
| TNFRSF1B | tumor necrosis factor | NM32315 | CAATGAAAGTTTGCACTGTATG | 51 |
| | receptor superfamily, | | CTGGACGGCATTCCTGCTTATC | |
| | member 1B | | AATAAACCTGTTTGTT | |
| UBB | ubiquitin B | NM_018955 | TGTTAATTCTTCAGTCATGGCA | 52 |
| | | | TTCGCAGTGCCCAGTGATGGC | |
| | | | ATTACTCTGCACTATAG | |
| UBC | ubiquitin C | M26880 | GGGTGTCTAAGTTTCCCCTTTT | 53 |
| | | | AAGGTTTCAACAAATTTCATTG | |
| | | | CACTTTCCTTTCAATA | |
| UCP2 | uncoupling protein 2 | AF096289 | TCTTCCTTCCGCTCCTTTACCT | 54 |
| | (mitochondrial, proton | | ACCACCTTCCCTCTTTCTACAT | |
| | carrier) | | TCTCATCTACTCATTG | |

### Statistical Analysis

A gene by gene analysis of the normalized data was performed by the R package limma2 on a restricted subset of patients divided in three groups matching for age, sex and smoke and according to their BMI and their diabetic status (see table 2). This package makes use of an adapted version of the hierarchical model proposed by Lonnstedt and Speed (Lonnstedt and Speed (2002). Replicated microarray data. Stat. Sinica, 12, 31-46). The central idea is to fit a general linear model with arbitrary coefficients and contrasts of interest, to the expression data for each gene. The empirical Bayes approach shrinks the estimated sample variances towards a pooled estimate, resulting in a far more stable inference (Smyth G (2004). Linear Models and Empirical Bayes Methods for Assessing Differential Expression in Microarray Experiments. Statistical Applications in Genetics and Molecular Biology, Vol. 3, No. 1, Article 3).

Next to this gene-by-gene approach, cluster and discriminant analysis was performed, using the whole patient set (see table 1), on the whole dataset as well as on a subset of genes to classify and predict which patients are diabetic obese and which patients are non-diabetic obese.

To cluster the patients, we used Ward's hierarchical clustering method. This method minimizes “the information loss”, that is associated with each grouping. Information loss is defined in terms of an error sum-of-squares.

Discriminant Analysis was done using the R package RDA4. This package applies a shrunken centroid Regularized Discriminant Analysis method to high dimension, low sample size data sets such as microarray data.

The Ingenuity Pathway Analysis software (Ingenuity System, Inc.) was used to identify specific biological pathways according to the observed gene profiles.

### Results:

### 1. Gene by Gene Analysis

Three different comparisons were performed: the obese (O) group was compared to the healthy donors (H) group (O/H) and the obese diabetics (OD) group was compared to the H group (OD/H) and to the O Group (OD/O). Results are summarized in table 4.

TABLE 4

| | O/H | OD/H | OD/O | O/H | OD/H | OD/O | |
|---|---|---|---|---|---|---|---|
| ID | FC1 | FC2 | FC | Changes | | | Category |
| CRP | 0.00 | 0.47 | 0.39 | — | > | > | A |
| IL2RB | 0.00 | 0.38 | 0.47 | — | > | > | A |
| C1QL1 | 0.00 | 0.56 | 0.98 | — | > | > | A |
| ELA2 | 0.00 | 0.39 | 0.38 | — | > | > | A |
| RPL38 | 0.00 | −0.67 | −0.74 | — | < | < | A |
| FTH1 | 0.00 | −1.07 | −0.71 | — | < | < | A |
| MYL6 | 0.00 | −0.81 | −0.70 | — | < | < | A |
| ARF1 | 0.00 | −0.54 | −0.63 | — | < | < | A |
| EIF4G2 | 0.00 | −0.57 | −0.52 | — | < | < | A |
| TNFRSF1B | 0.00 | −0.71 | −0.50 | — | < | < | A |
| RPL13A | 0.00 | −0.41 | −0.48 | — | < | < | A |
| CD3D | 0.00 | −0.62 | −0.43 | — | < | < | A |
| GNB2 | 0.00 | −0.34 | −0.42 | — | < | < | A |
| HSPA1A | 0.00 | −0.48 | −0.39 | — | < | < | A |
| MAZ | 0.00 | −0.45 | −0.34 | — | < | < | A |
| COX7C | 0.00 | −0.57 | −0.28 | — | < | < | A |
| SRP14 | 0.00 | −0.39 | −0.17 | — | < | < | A |
| CXCR4 | 0.00 | −0.64 | −0.34 | — | < | < | A |
| UBC | 0.00 | −0.78 | −0.46 | — | < | < | A |
| SMT3H2 | 0.00 | −0.46 | −0.43 | — | < | < | A |
| CD14 | 0.00 | −0.30 | −0.15 | — | < | — | A |
| HSPCB | 0.00 | −0.33 | −0.25 | — | < | — | A |
| CFL1 | 0.52 | −0.59 | −0.98 | > | < | < | B |
| CCR7 | 0.23 | −0.46 | −0.61 | > | < | < | B |
| IL5 | −0.31 | 0.00 | 0.15 | < | — | — | C |
| HMOX1 | −0.43 | 0.00 | 0.61 | < | — | > | C |
| IL11 | −0.22 | 0.00 | 0.43 | < | — | > | C |
| OGG1 | −0.43 | 0.00 | 0.29 | < | — | > | C |
| SERPINE1 | −0.47 | 0.00 | 0.42 | < | — | > | C |
| PRDX1 | 0.33 | 0.00 | −0.10 | > | — | — | C |
| GPX1 | 0.79 | 0.00 | −0.74 | > | — | < | C |
| IL2RG | 0.56 | 0.00 | −0.50 | > | — | < | C |
| UBB | 0.86 | 0.00 | −0.51 | > | — | < | C |
| UCP2 | 0.54 | 0.00 | −0.46 | > | — | < | C |
| HSPB1 | 0.25 | 0.25 | 0.01 | > | > | — | D |
| PRDX2 | 0.27 | 0.35 | 0.09 | > | > | — | D |
| FOS | −0.92 | −0.82 | 0.13 | < | < | — | D |
| RPS18 | −0.37 | −0.74 | −0.20 | < | < | — | D |
| PDIA3 | −0.32 | 0.00 | 0.45 | — | — | > | E |
| IL3 | −0.16 | 0.23 | 0.30 | — | — | > | E |
| DNAJB1 | −0.15 | 0.16 | 0.31 | — | — | > | E |
| ADAR | 0.15 | −0.17 | −0.40 | — | — | < | E |
| GCLC | 0.27 | −0.17 | −0.33 | — | — | < | E |

log² fold changes (FC) of obeses (O) versus healthy controls (H), diabetic obeses (OD) versus H and OD versus O.
p < 0.05 *, adjusted p < 0.05 **
Changes: — no; > upregulated; < down regulated

All the results are expressed as log₂ fold changes (log₂ FC). Only genes with a corrected p value<0.05 in at least one of the three comparison were selected for the analysis.

43 genes with differential expression levels in at least one of the three comparisons were identified. According to the three comparisons it was possible to classify the genes in different categories:
22 genes that are differentially expressed in OD versus H but not in O versus H (category A)
2 genes that are differentially expressed in OD versus H and differentially expressed in the opposite way in O versus H (category B)
10 genes that are differentially expressed in O versus H but not in OD versus H (category C)
4 genes that are differentially expressed in OD versus H and differentially expressed in the same way in O versus H (category D)
5 genes that are neither differentially expressed in OD versus H nor in O versus H but. Nevertheless, these genes are differentially expressed in OD versus O (category E).

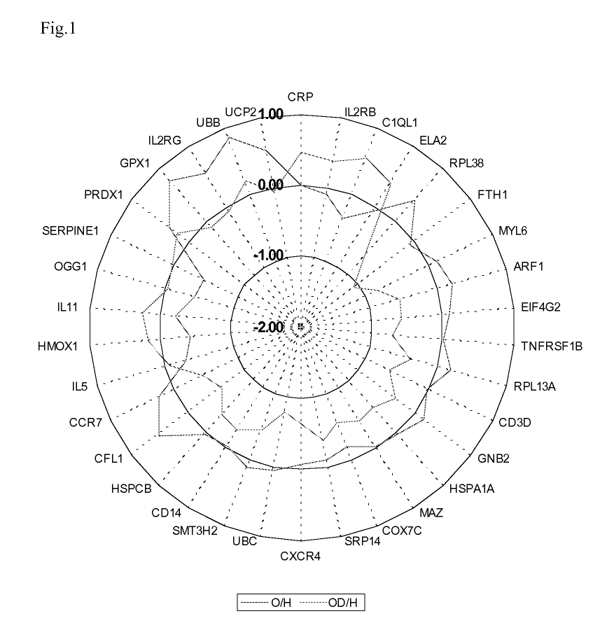

According to their different behaviors in obese persons compared to diabetic obese persons, we assumed that the profiling of genes belonging to categories A, B and C could be a new approach to diagnosis of diabetes in obese individuals or to prognosis of the onset of diabetes in obese individuals. Their expression profiles are summarized in FIG. 1.

According to their similar behaviors in obese persons compared to diabetic obese persons, the genes belonging to category D seem to be more related to the obesity status.

Genes belonging to class E are differentially expressed in diabetic obese persons compared to obese persons. This is mainly due to the fact that these genes are differentially expressed in OD versus H and differentially expressed in an opposite way in O versus H. These expressions are not statistically significant but contribute to increase the difference between OD and O.

### 2. Cluster Analysis.

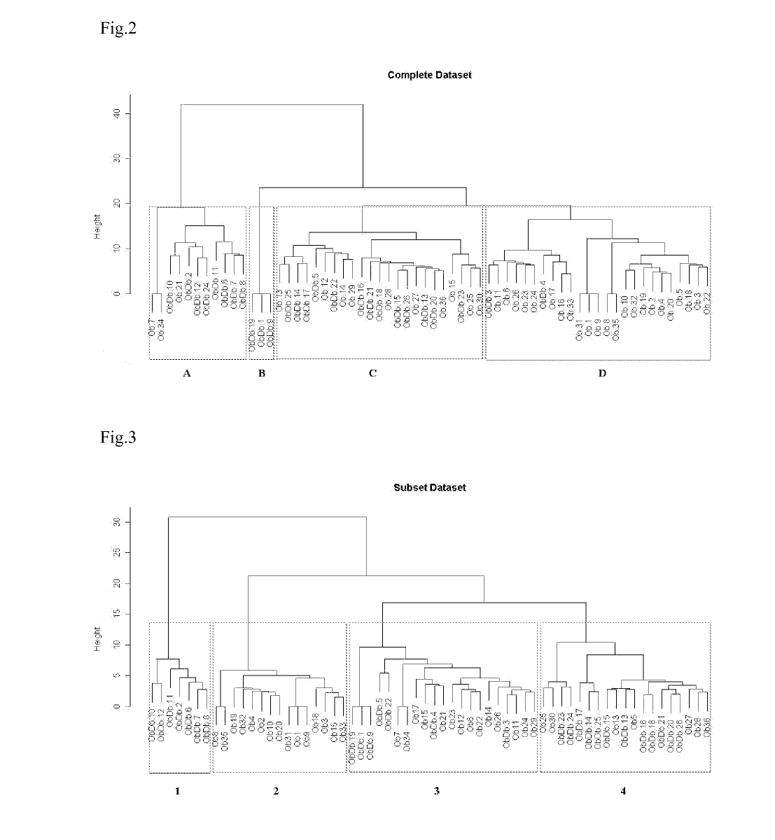

Applying Ward's hierarchical clustering analyses using Euclidean distance on the normalized log₂FC of the whole dataset (FIG. 2) revealed four clusters: cluster A with 11 patients (8 diabetic obese and 3 non-diabetic obese), cluster B with 3 patients (all diabetic obese), cluster C with 26 patients (16 diabetic obese and 10 non-diabetic obese) and cluster D with 25 patients (23 non-diabetic obese and 3 diabetic obese).

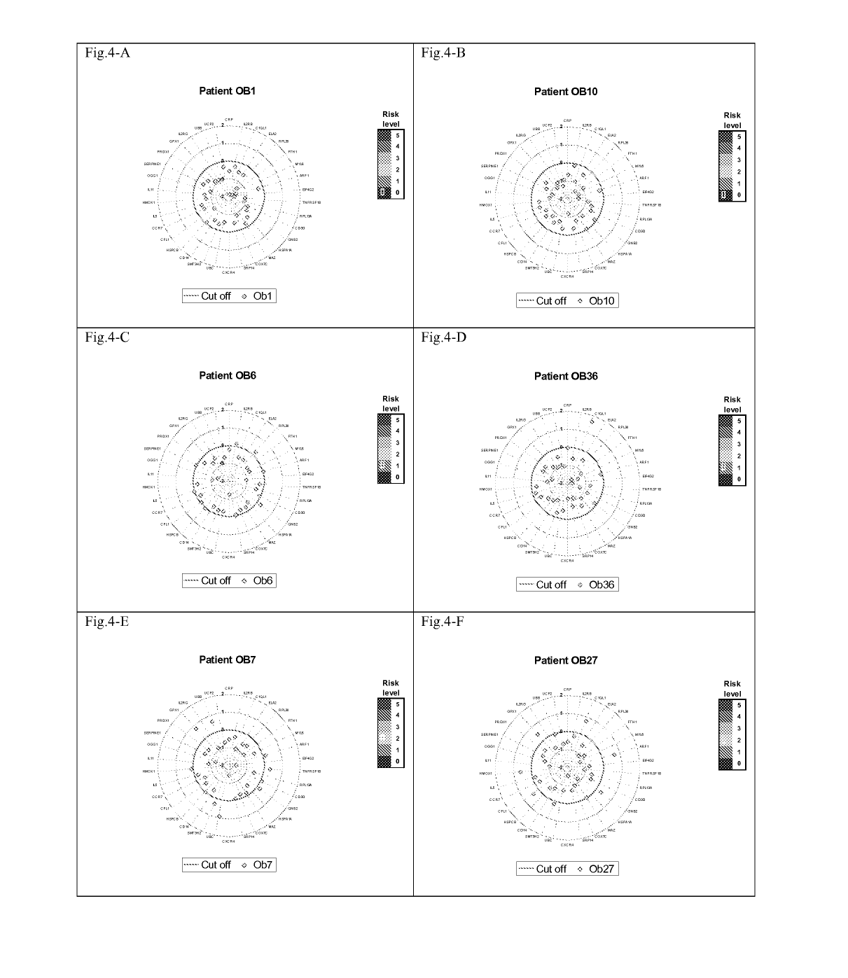

We also applied the same clustering method on the log 2FC information of the subset of genes (N=34) (FIG. 3) that were identified after analysis with limma (see Table 4). We observed four clusters: cluster 1 with 7 patients (all diabetic obese), cluster 2 with 15 patients (all non-diabetic obese), cluster 3 with 21 patients (14 non diabetic obese and 7 diabetic obese) and cluster 4 with 19 patients (12 diabetic obese and 7 non-diabetic obese).

### 3. Discriminant Analysis.

Shrunken Centroid Regularized Discriminant Analysis4 was used to build two separate classifiers. The training set consisted out of 13 randomly chosen obese patients who had been diagnosed with diabetes and 18 randomly chosen non-diabetic obese patients. The test set consisted out of 31 patients (13 diabetic obese, 18 non-diabetic obese).

The first classifier was built with the log 2FC information of all genes. The error rate of this classifier was 41.94% and had a sensitivity of 53.85% and a specificity of 61.11%.

A second classifier, with the log 2FC information of the subset of genes, was built and performed better than the first classifier. The error rate had dropped down to 25.81% and the sensitivity and specificity rose respectively to 69.23% and 77.78%.

Table 5 gives an overview of the clustering and classification results. This table shows the importance of using the subset of genes instead of using the complete dataset. Cluster C from the complete dataset has been split up in two new clusters: cluster 3 and cluster 4. All misclassified non-diabetic obese patients can be found in these two clusters.

All (correctly classified and misclassified) patients in these clusters have gene expression profiles that are closer to each other than to patient profiles observed in cluster 1 or 2.

Importantly, the clustering was not influenced by other conditions like gender, smoking or the use of oral contraception.

Based upon these facts and based upon the fact that some of the genes that are responsible for this “misclassification” are closely related to diabetes, we may state that non-diabetic obese patients in these clusters will have a higher chance of developing diabetes than the patients in cluster 2. Non-diabetic obese patients in cluster 4 even have a higher probability of developing diabetes than non-diabetic obese patients in cluster 3, as the majority of the patients in cluster 4 are diabetic obese patients (63.16%).

TABLE 5
Overview of clustering and classification results.

| | COMPLETE | | | SUBSET | | |
|---|---|---|---|---|---|---|
| | Clus- | | | Clus- | | |
| Patient | ter | D-odds | O-odds | ter | D-odds | O-odds |
| Ob 1 | D | 0.038502 | 0.961498 | 2 | 0.000497 | 0.999503 |
| Ob 10 | D | 0.025853 | 0.974147 | 2 | 0.000947 | 0.999053 |
| Ob 13 | C | 0.77287 | 0.22713 | 4 | 0.125986 | 0.874014 |
| Ob 14 | C | 0.704216 | 0.295784 | 3 | 0.664464 | 0.335536 |
| Ob 17 | D | 0.247429 | 0.752571 | 3 | 0.667783 | 0.332217 |
| Ob 2 | D | 0.048861 | 0.951139 | 2 | 9.63E−05 | 0.999904 |
| Ob 20 | D | 0.029194 | 0.970806 | 2 | 0.014759 | 0.985241 |
| Ob 21 | A | 0.881706 | 0.118294 | 3 | 0.000341 | 0.999659 |
| Ob 23 | D | 0.195189 | 0.804811 | 3 | 0.996351 | 0.003649 |
| Ob 24 | D | 0.242939 | 0.757061 | 3 | 0.019112 | 0.980888 |
| Ob 26 | D | 0.26216 | 0.73784 | 3 | 0.064673 | 0.935327 |
| Ob 27 | C | 0.794673 | 0.205327 | 4 | 0.21567 | 0.78433 |
| Ob 29 | C | 0.560387 | 0.439613 | 3 | 0.320819 | 0.679181 |
| Ob 3 | D | 0.055168 | 0.944832 | 2 | 0.000712 | 0.999288 |
| Ob 30 | C | 0.969119 | 0.030881 | 4 | 0.971906 | 0.028094 |
| Ob 36 | C | 0.755236 | 0.244764 | 4 | 0.008931 | 0.991069 |
| Ob 4 | D | 0.019046 | 0.980954 | 2 | 0.000389 | 0.999611 |
| Ob 9 | D | 0.038502 | 0.961498 | 2 | 0.000497 | 0.999503 |
| ObDb 1 | B | 0.348414 | 0.651586 | 3 | 0.756774 | 0.243226 |
| ObDb 12 | A | 0.978592 | 0.021408 | 1 | 0.999974 | 2.61E−05 |
| ObDb 14 | C | 0.913078 | 0.086922 | 4 | 0.536467 | 0.463533 |
| ObDb 16 | C | 0.967735 | 0.032265 | 4 | 0.787228 | 0.212772 |
| ObDb 17 | C | 0.816912 | 0.183088 | 4 | 0.451823 | 0.548177 |
| ObDb 2 | A | 0.454004 | 0.545996 | 1 | 0.998547 | 0.001453 |
| ObDb 20 | C | 0.620077 | 0.379923 | 4 | 0.098942 | 0.901058 |
| ObDb 22 | C | 0.055412 | 0.944588 | 3 | 0.006388 | 0.993612 |
| ObDb 23 | C | 0.929353 | 0.070647 | 4 | 0.947942 | 0.052058 |
| ObDb 26 | C | 0.664246 | 0.335754 | 4 | 0.016821 | 0.983179 |
| ObDb 5 | C | 0.060858 | 0.939142 | 3 | 0.632146 | 0.367854 |
| ObDb 7 | A | 0.262591 | 0.737409 | 1 | 0.973621 | 0.026379 |
| ObDb 8 | A | 0.175838 | 0.824162 | 1 | 0.998062 | 0.001938 |

D-odds: posterior odds of patient x to belong to the diabetic obese patients group
O-odds: posterior odds of patient x to belong to the non-diabetic obese patients group

### 4. Risk Scale for Obese Persons to Become Diabetic

According to the results we have obtained, we build up a risk scale for obese persons to become diabetic. Therefore, we have considered the group of patients belonging to cluster 1 as the reference group for diabetic obese persons and the group of patients belonging to cluster 2 as the reference group for non-diabetic obese persons. Then, for each of the 34 selected genes, we calculated the best cut-off giving 100% specificity (no gene detected in any patient of cluster 2). The cut-offs and the corresponding sensitivities for each gene are shown in table 6.

TABLE 6

| | | Sensitivity | Specificity |
|---|---|---|---|
| ID | Cut off | (%) | (%) |
| CRP | >0.4 | 100 | 100 |
| IL2RB | >0.2 | 29 | 100 |
| C1QL1 | >0 | 29 | 100 |
| ELA2 | >0.4 | 43 | 100 |
| RPL38 | <−0.8 | 71 | 100 |
| FTH1 | <−1.4 | 57 | 100 |
| MYL6 | <−0.3 | 86 | 100 |
| ARF1 | <0 | 100 | 100 |
| EIF4G2 | <−0.6 | 100 | 100 |
| TNFRSF1B | <−1 | 100 | 100 |
| RPL13A | <−0.9 | 29 | 100 |
| CD3D | <−0.7 | 71 | 100 |
| GNB2 | <−0.2 | 71 | 100 |
| HSPA1A | <−0.7 | 86 | 100 |
| MAZ | <−0.3 | 86 | 100 |
| COX7C | <−1 | 29 | 100 |
| SRP14 | <−0.7 | 71 | 100 |
| CXCR4 | <−1.8 | 14 | 100 |
| UBC | <−0.6 | 100 | 100 |
| SMT3H2 | <−0.5 | 71 | 100 |
| CD14 | <−0.7 | 57 | 100 |
| HSPCB | <−0.2 | 100 | 100 |
| CFL1 | <0 | 100 | 100 |
| CCR7 | <−0.3 | 86 | 100 |
| IL5 | >0 | 71 | 100 |
| HMOX1 | >0 | 57 | 100 |
| IL11 | >0.6 | 57 | 100 |
| OGG1 | >0.8 | 14 | 100 |
| SERPINE1 | >0.1 | 71 | 100 |
| PRDX1 | <−0.1 | 29 | 100 |
| GPX1 | <0 | 57 | 100 |
| IL2RG | <−0.2 | 86 | 100 |
| UBB | <0 | 71 | 100 |
| UCP2 | <0 | 100 | 100 |

Cut-offs< or >x means that the corresponding gene log 2 fold change must be < or > then x. The specificity for each gene is defined as the % of patients from cluster 1 with a correspondent fold change that is < or >x.

For each patient it was then possible to calculate the number of genes that were < or > to their respective cut-offs as well as the sum of the distances of the different genes from their respective cut offs (□ DTCO). The distances to the cut offs (DTCO) were calculated as following:

For genes that are upregulated in diabetes, DTCO=log 2FC−cut off and for genes that are downregulated in diabetes, DTCO=−(log 2FC−cut off).

The results are show in table 7

Mean □ DTCO was 14.7 for cluster 1, 0 for cluster 2, 3.7 for the diabetic obese sub-group of cluster 3, 2.5 for the non diabetic obese sub-group of cluster 3, 4.2 for the diabetic obese sub-group of cluster 4 and 3.3 for the non diabetic obese sub-group of cluster 3.

TABLE 7

| | | Nbr of genes | □ distances |
|---|---|---|---|
| Patients | Clusters | detected | from cut off |
| ObDb 2 | 1.00 | 21 | 12.2 |
| ObDb 6 | 1.00 | 20 | 13.4 |
| ObDb 7 | 1.00 | 20 | 5.4 |
| ObDb 8 | 1.00 | 25 | 12.4 |
| ObDb 10 | 1.00 | 21 | 16.7 |
| ObDb 11 | 1.00 | 28 | 26.0 |
| ObDb 12 | 1.00 | 26 | 16.7 |
| Ob1 | 2.00 | 0 | 0.0 |
| Ob2 | 2.00 | 0 | 0.0 |
| Ob3 | 2.00 | 0 | 0.0 |
| Ob4 | 2.00 | 0 | 0.0 |
| Ob8 | 2.00 | 0 | 0.0 |
| Ob9 | 2.00 | 0 | 0.0 |
| Ob10 | 2.00 | 0 | 0.0 |
| Ob16 | 2.00 | 0 | 0.0 |
| Ob18 | 2.00 | 0 | 0.0 |
| Ob19 | 2.00 | 0 | 0.0 |
| Ob20 | 2.00 | 0 | 0.0 |
| Ob31 | 2.00 | 0 | 0.0 |
| Ob32 | 2.00 | 0 | 0.0 |
| Ob33 | 2.00 | 0 | 0.0 |
| Ob35 | 2.00 | 0 | 0.0 |
| ObDb 1 | 3.00 | 12 | 3.0 |
| ObDb 3 | 3.00 | 8 | 1.1 |
| ObDb 4 | 3.00 | 10 | 5.0 |
| ObDb 5 | 3.00 | 13 | 6.4 |
| ObDb 9 | 3.00 | 12 | 3.0 |
| ObDb 19 | 3.00 | 12 | 3.0 |
| ObDb 22 | 3.00 | 7 | 4.0 |
| Ob6 | 3.00 | 7 | 0.8 |
| Ob7 | 3.00 | 11 | 3.4 |
| Ob11 | 3.00 | 8 | 1.2 |
| Ob12 | 3.00 | 10 | 1.6 |
| Ob14 | 3.00 | 9 | 4.1 |
| Ob15 | 3.00 | 13 | 2.8 |
| Ob17 | 3.00 | 5 | 1.9 |
| Ob21 | 3.00 | 14 | 8.0 |
| Ob22 | 3.00 | 2 | 0.6 |
| Ob23 | 3.00 | 3 | 1.8 |
| Ob24 | 3.00 | 6 | 0.7 |
| Ob26 | 3.00 | 9 | 2.0 |
| Ob29 | 3.00 | 9 | 2.4 |
| Ob34 | 3.00 | 11 | 3.4 |
| ObDb 13 | 4.00 | 7 | 1.7 |
| ObDb 14 | 4.00 | 10 | 4.5 |
| ObDb 15 | 4.00 | 8 | 3.0 |
| ObDb 16 | 4.00 | 10 | 4.1 |
| ObDb 17 | 4.00 | 11 | 5.8 |
| ObDb 18 | 4.00 | 10 | 3.2 |
| ObDb 20 | 4.00 | 5 | 1.9 |
| ObDb 21 | 4.00 | 7 | 1.4 |
| ObDb 23 | 4.00 | 14 | 8.2 |
| ObDb 24 | 4.00 | 14 | 10.6 |
| ObDb 25 | 4.00 | 8 | 4.8 |
| ObDb 26 | 4.00 | 4 | 1.4 |
| Ob5 | 4.00 | 5 | 1.2 |
| Ob13 | 4.00 | 5 | 2.4 |
| Ob25 | 4.00 | 7 | 5.7 |
| Ob27 | 4.00 | 8 | 3.3 |
| Ob28 | 4.00 | 3 | 1.2 |
| Ob30 | 4.00 | 12 | 7.6 |
| Ob36 | 4.00 | 1 | 1.7 |

As expected, a maximum of genes (20 to 28) are detected in cluster 1 and none in cluster 2. The number of genes detected ranges from 2 to 14 in cluster 3 and from 1 to 14 in cluster 4.

According to these results, we set up the following risk scoring for obese patients to develop diabetes

Risk level 0: □ DTCO=0
Risk level 1: □ DTCO>0 up to 2
Risk level 2: □ DTCO>2 up to 4
Risk level 3: □ DTCO>4 up to 6
Risk level 4: □ DTCO>6 up to 8
Risk level 5: □ DTCO>8

According to these rules, each obese patient can be characterized by a graphical representation of the □ DTCO his genes as well as by a score scale.

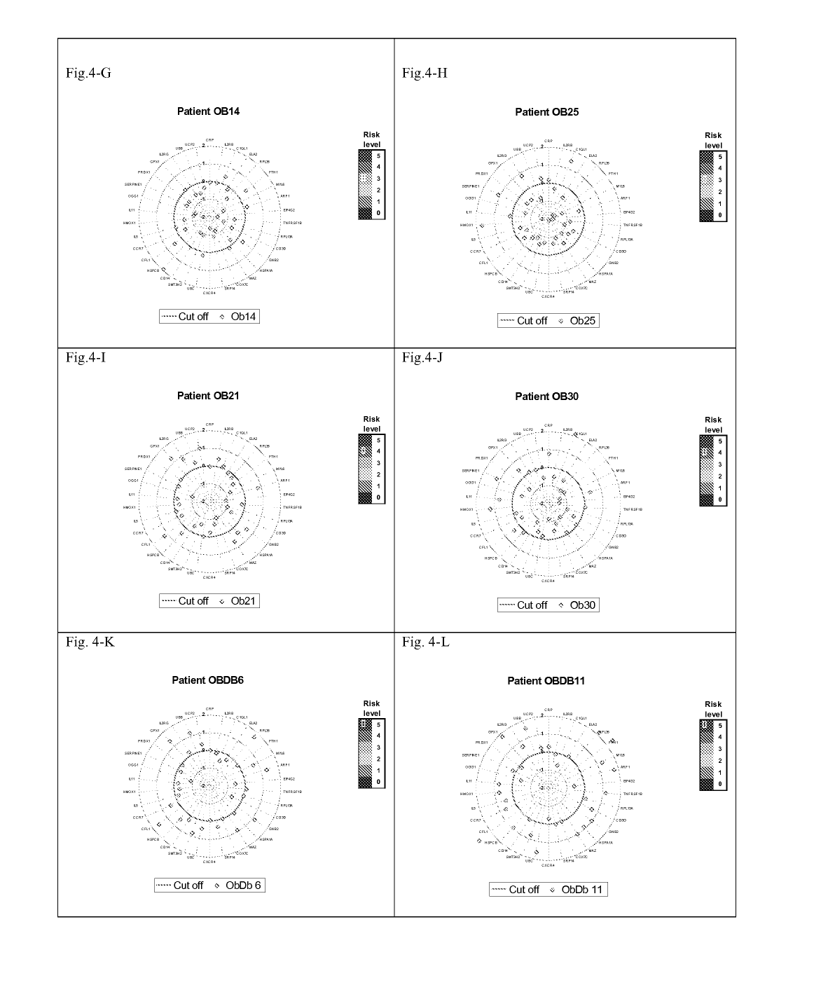

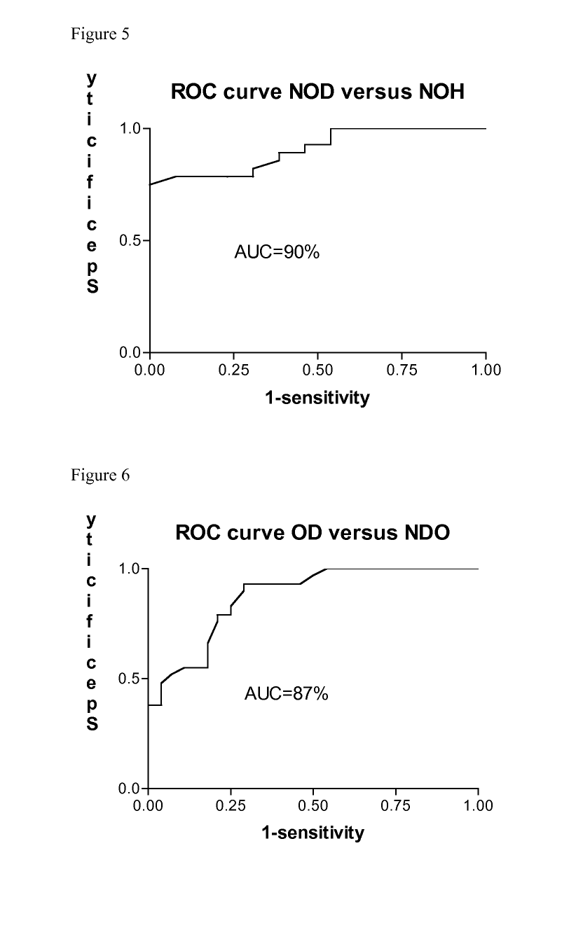

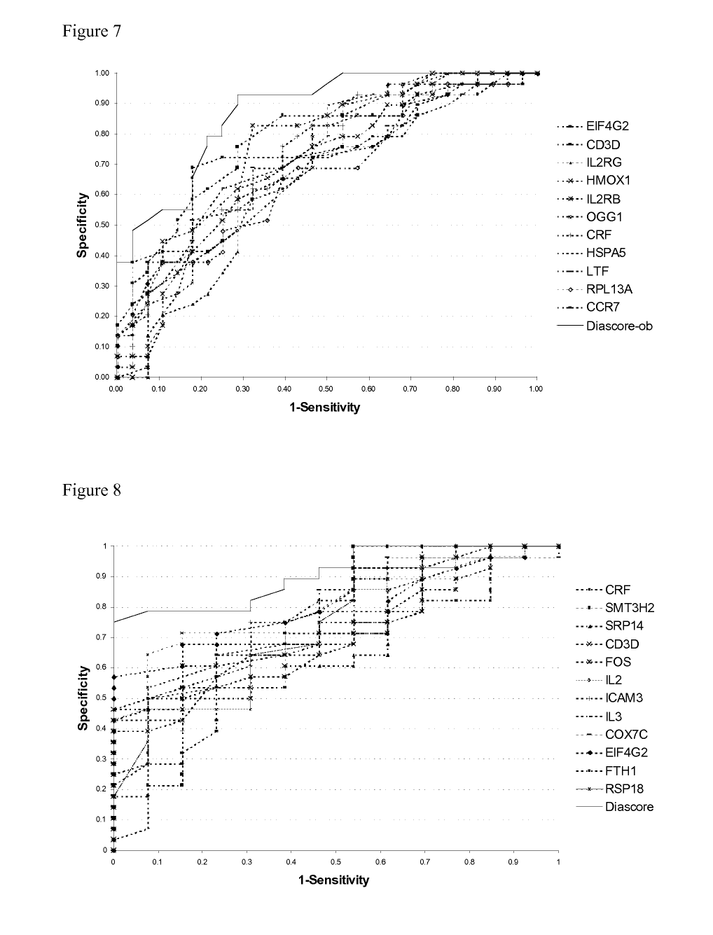

The profiles of 12 different patients are shown in FIGS. 4-A to 4-L.

### 5. Subset 2 and 3 Obese-Diabetic

Based upon table 6, we selected 8 genes (see table 8) which had a specificity and sensitivity of 100% and repeated the discriminant analysis. The third classifier was built with the same patients in the training set as before, to make comparisons between the first two classifiers (all genes and the first subset of genes) and this classifier possible.

Although the specificity rose to 83.33%, this classifier performed worse than the second classifier: the error rate became 29% and the sensitivity dropped to the level of the first classifier (53.84%). This may be explained be the fact that only 8 genes are used as a “guideline”.

Therefore we added all genes with a sensitivity □86%. The subset consisted now out of 13 genes (see table 8). A new classifier was built and performed better than the previous classifiers. The error rate of this classifier dropped to 19.35% and the specificity reached 88.88%. The sensitivity of this classifier stayed at the same level as the second classifier (69.23% with 34 genes as “guideline”).

TABLE 8
Subset 2 and 3

| | Sensitivity | Specificity | |
|---|---|---|---|
| ID | (%) | (%) | Subset |
| CRP | 100% | 100% | 2 + 3 |
| ARF1 | 100% | 100% | 2 + 3 |
| EIF4G2 | 100% | 100% | 2 + 3 |
| HSPCB | 100% | 100% | 2 + 3 |
| CFL1 | 100% | 100% | 2 + 3 |
| TNFRSF1B | 100% | 100% | 2 + 3 |
| UBC | 100% | 100% | 2 + 3 |
| UCP2 | 100% | 100% | 2 + 3 |
| CCR7 | 86% | 100% | 3 |
| HSPA1A | 86% | 100% | 3 |
| IL2RG | 86% | 100% | 3 |
| MAZ | 86% | 100% | 3 |
| MYL6 | 86% | 100% | 3 |

### Example 2

In a further example, we assessed the potency of the method to distinguish obese diabetics from non-diabetic obese subjects and non-obese diabetics from healthy subjects in a diagnosis perspective, we performed a gene by gene analysis on a new whole patient set including healthy subjects (H), non-diabetic obese subjects (O), diabetic obese subjects (DO) and non-obese diabetic subjects (D). The characteristics of the patients set are shown in table 9. The gene-by-gene analysis of the normalized data was performed by the R package limma2 as described hereinbefore. Four different comparisons were performed: the non-diabetic obese group was compared to the healthy group (O/H), the obese diabetic group was compared to the healthy (OD/H) and to the non-diabetic obese group (OD/O) and the non-obese diabetic group was compared to the healthy group (D/H). Results are summarized in table 10.

TABLE 9
subjects characteristics

| | Non-diabetic | Diabetic | Non-obese | |
|---|---|---|---|---|
| | obese | obese | diabetic | Healthy |
| | subjects | subjects | subjects | subjects |
| Characteristics | (O) | (DO) | (D) | (H) |
| Male | 6 | 14 | 6 | 8 |
| Female | 23 | 14 | 7 | 20 |
| Pill | 10 | 2 | 1 | 5 |
| Smokers | 9 | 9 | 6 | 9 |
| BMI (avg ± sd) | 39.8 ± 6.3 | 39.6 ± 10.0 | 22.4 ± 2.8 | 22.5 ± 2.0 |
| Age (avg ± sd) | 38.3 ± 12.9 | 57.1 ± 11.1 | 51.2 ± 18.9 | 37.4 ± 13.3 |
| Total | 29 | 28 | 13 | 28 |

Table 10 shows the mean relative log 2 fold changes (log 2FC) of each group versus its comparator and the corresponding adjusted P values. Only genes with a statistically significant adjusted P (<0.05) were selected.

42 genes with a significant differential expression in at least one of the four comparisons were identified. Among them, 29 were genes already selected by the prognosis analysis (in black) and 13 genes were newly identified (in red).

A first subset of 21 genes differentiates obese subjects from healthy ones. Another subset of 33 genes differentiates diabetic obese subjects from healthy ones. A third subset of 11 genes differentiates obese diabetic subjects from non-diabetic obese subjects and a fourth subset of 11 genes differentiates non-obese diabetics from healthy subjects.

The two later signatures have then been used to calculate scores allowing differentiating (1) diabetic obese subjects among the non-diabetic obese population (DIASCORE_OB) and (2) non-obese diabetics among the healthy population (DIASCORE).

These scores are calculated as following:

$$DIASCORE\_OB = \begin{matrix}{•}_{o = 1}^{x} log 2 {FC}_{o} - & {•}_{d = 1}^{y} log 2 {FC}_{d}\end{matrix}$$

were

Log 2FCₒ=normalized expression of the subject−mean normalized expression of the non-diabetic obese reference group of the x genes that are over expressed in the obese diabetic group compared to the non-diabetic obese reference group and

Log 2FC_{d}=normalized expression of the subject−mean normalized expression of the non-diabetic obese reference group of the y genes that are down expressed in the obese diabetic group compared to the non-diabetic obese reference group.

$$DIASCORE = \begin{matrix}{•}_{o = 1}^{n} log 2 {FC}_{o} - & {•}_{d = 1}^{m} log 2 {FC}_{d}\end{matrix}$$

were

Log 2FCₒ=normalized expression of the subject−mean normalized expression of the heathy reference group of the n genes that are over expressed in the non obese diabetic group compared to the healthy reference group and

Log 2FC_{d}=normalized expression of the subject−mean normalized expression of the healthy reference group of the m genes that are down expressed in the non-obese diabetic group compared to the healthy reference group.

We first calculated the scores obtained by each individual gene. ROC curves (receiver operating characteristics) were drawn and corresponding AUC (area under the curve) calculated to determine the precision of the corresponding scores to discriminate the target population from its reference population. Results are shown in table 11 and 12. AUC's ranged from 70 to 79 for the discrimination of non-obese diabetics from healthy subjects and from 67 to 76 for the discrimination of obese diabetics from non-diabetic obese subjects. We then calculated ROC and AUC for different combination of genes (from two to 11 genes) starting from the lowest or the highest AUC values (table 11 and 12). Starting from the lowest AUC values, we reached the best precision with the full set of genes (AUC=88 and 86 for D from H and OD from O discrimination respectively). Starting from the highest AUC values, the best precision was reached with the combination of a subset of 9 genes (AUC=90 and 87 for D from H and OD from O discrimination respectively). This means that the two genes with the lowest AUC values do not contribute to the precision of the tests.

Two definitive sets of 9 genes were then selected for the calculation of the DIASCORE and the DIASCORE_OB. The corresponding ROC curves are presented in FIGS. 5 and 6.

The DIASCORE (FIG. 5) is calculated according to the 9-gene signature differentiating non-obese diabetics from healthy subjects, based on the following genes CD3D, FOS, IL2, ICAM3, IL3, COX7C, EIF4G2, FTH1, RSP18. The score ranges from 0 to 15. Mean scores are 6 and 11 for healthy donors and non-obese diabetics respectively. A score above 8 allows distinguishing the diabetic subjects from the healthy subjects with a sensitivity of 92% and a specificity of 79%. The area under the curve (AUC) is 90%.

TABLE 10
Gene subsets discriminating the different groups of patients.

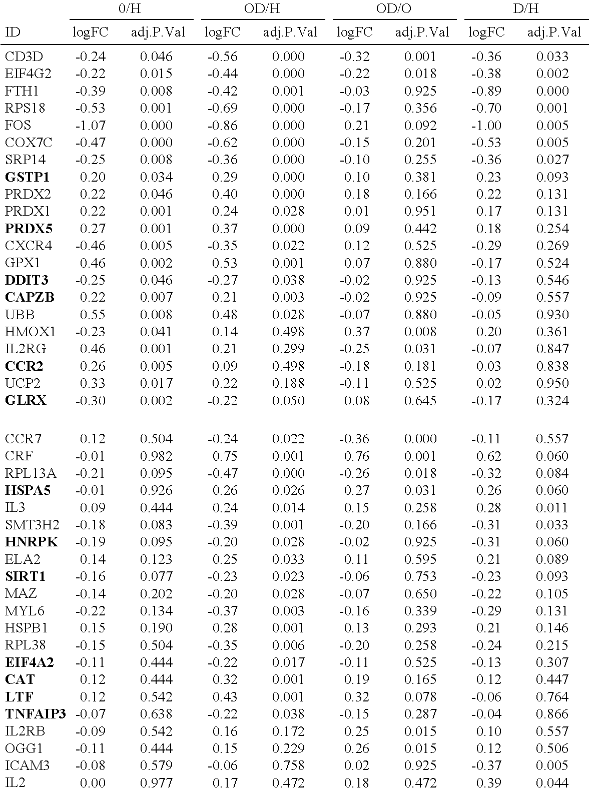

Gene subsets discriminating the diabetic obese from the healthy group (O/H), the obese diabetic from the healthy group (OD/H) and from the non-diabetic obese group (OD/O) and the non-obese diabetic group from the healthy group (D/H) are shown in the gray zones.
Gene already selected by the prognosis analysis and new selected genes are types in normal or bold respectively.

TABLE 11
AUC of individual and combinations of genes used
to discriminate diabetics from healthy subjects
D/H

| Genes | | AUC | | | | | | | | | |
|---|---|---|---|---|---|---|---|---|---|---|---|
| SMT3H2 | 70 | | | | | | | | | | 88 |
| SRP14 | 70 | 73 | | | | | | | | 89 | |
| CD3D | 70 | | 73 | | | | | | 90 | | |
| FOS | 72 | | | 76 | | | | 88 | | | |
| IL2 | 72 | | | | 81 | | 87 | | | | |
| ICAM3 | 74 | | | | | 85/88 | | | | | |
| IL3 | 75 | | | | 87 | | 86 | | | | |
| COX7C | 76 | | | 87 | | | | 86 | | | |
| EIF4G2 | 77 | | 88 | | | | | | 86 | | |
| FTH1 | 79 | 83 | | | | | | | | 88 | |
| RSP18 | 79 | | | | | | | | | | 88 |

AUC of individual genes (left column) and of combinations of genes starting from the lowest AUC (in bold) or from the highest AUC (in bold underlined).

TABLE 12
AUC of individual and combinations of genes used to discriminate
obese diabetics from non-diabetic obese subjects
OD/O

| Genes | | AUC | | | | | | | | | |
|---|---|---|---|---|---|---|---|---|---|---|---|
| IL2RG | 67 | | | | | | | | | | 86 |
| RPL13A | 67 | 72 | | | | | | | | 86 | |
| LTF | 67 | | 74 | | | | | | 87 | | |
| EIF4G2 | 69 | | | 75 | | | | 86 | | | |
| OGG1 | 70 | | | | 77 | | 85 | | | | |
| HMOX1 | 72 | | | | | 84/78 | | | | | |
| CRF | 72 | | | | 83 | | 82 | | | | |
| HSPA5 | 73 | | | 83 | | | | 84 | | | |
| CD3D | 73 | | 79 | | | | | | 84 | | |
| IL2RB | 74 | 76 | | | | | | | | 86 | |
| CCR7 | 76 | | | | | | | | | | 86 |

AUC of individual genes (left column) and of combinations of genes starting from the lowest AUC (in bold) or from the highest AUC (in bold underlined).

The DIASCORE_OD (FIG. 6) is calculated according to the 9-gene signature differentiating obese diabetics from non-diabetic obese subjects, base on the following genes LTF, EIF4G2, OGG1, HMOX1, CRF, HSPA5, CD3D, IL2RB, CCR7. The score range from 0 to 12. Mean scores are 3.5 and 6.6 for non diabetic obese subjects and diabetics obese subjects respectively. A score above 4.5 allows distinguishing the obese diabetic subjects from the non-diabetic obese subjects with a sensitivity of 75% and a specificity of 75%. The area under the curve (AUC) is 87%.

The comparison between ROC curves obtained with scores calculated from individual gene and from the 9-gene-based DIASCORE and DIASCORE_OD are shown in FIGS. 7 and 8 respectively.

So in conclusion, in a diagnosis perspective the subsets as indicated in table 10, are able to distinguish non-diabetic obese from healthy (O/H), obese diabetic from healthy (OD/H), obese diabetic from non-diabetic obese (OD/O) and non-obese diabetic from healthy (D/H), wherein a minimal set to differentiate diabetic from non-diabetic persons includes the genes of tables 1, and 12 above, in particular CD3D, FOS, IL2, ICAM3, IL3, COX7C, EIF4G2, FTH1, RSP18, LTF, OGG1, HMOX1, CRF, HSPA5, IL2RB, and CCR7.

1-15. (canceled)

16. An in vitro method for diagnosis or risk assessment of T2D in a critical person, said method comprising determining the expression level of at least two T2D marker genes selected from ARF1, CAPZB, CAT, CCR2, CCR7, CD14, CD3D, CFL1, COX7C, CRF, CRP, CSCR4, DDIT3, EIF4A2, EIF4G2, ELA2, FOS, FTH1, GLRX, GNB2, GPX1, GSTP1, HMOX1, HNRPK, HSPA1A, HSPA5, HSPCB, ICAM3, IL11, IL2, IL2RB, IL2RG, IL3, IL5, LTF, MAZ, MYL6, OGG1, PRDX1, PRDX5, RPL13A, RPL38, RPS18, SERPINE1, SIRT1, SMT3H2, SRP14, TNFAIP3, TNFRSF1B, UBB, UBC, and UCP2 in a biological sample taken from said person; and utilizing the profile of the expression levels of said T2D genes to diagnose the susceptibility of said person for T2D.

17. The method according to claim 16 wherein said at least two T2D genes are selected from CRP, IL2RB, CRF (C1QL1), ELA2, RPL38, FTH1, MYL6, ARF1, EIF4G2, TNFRSF1B, RPL13A, CD3D, GNB2, HSPA1A, MAZ, COX7C, SRP14, CXCR4, UBC, SMT3H2, CD14, HSPCB, CFL1, CCR7, IL5, HMOX1, IL11, OGG1, SERPINE 1, PRDX1, GPX1, IL2RG, UBB, and UCP2.

18. The method according to claim 16 further comprising comparing the expression level of said T2D genes with the mean expression levels of said T2D genes in a representative set of samples taken from non-T2D controls.

19. The method according to claim 16 comprising determining the expression levels of at least five of said genes.

20. The method according to claim 16 wherein said at least two T2D genes are selected from CRP, ARF1, EIF4G2, HSPCB, CFL1, TNFRSF1B, UBC, UCP2, CCR7, HSPA1A, IL2RG, MAZ, MYL6, SMT3H2, SRP14, CD3D, FOS, IL2, ICAM3, IL3, COX7C, EIF4G2, FTH1, RPS18, IL2RG, RPL13A, LTF, EIF4G2, OGG1, HMOX1, CRF, HSPA5, CD3D, and IL2RB.

21. The method according to claim 20 comprising determining the expression level of the genes selected from CRP, ARF1, EIF4G2, HSPCB, CFL1, TNFRSF1B, UBC, UCP2, CCR7, HSPA1A, IL2RG, MAZ, and MYL6.

22. The method according to claim 20 comprising determining the expression level of the genes selected from SMT3H2, SRP14, CD3D, FOS, IL2, ICAM3, IL3, COX7C, EIF4G2, FTH1, and RPS18.

23. The method according to claim 20 comprising determining the expression level of the genes selected from IL2RG, RPL13A, LTF, EIF4G2, OGG1, HMOX1, CRF, HSPA5, CD3D, IL2RB, and CCR7.

24. The method according to claim 16 wherein the expression level of the T2D marker genes is assessed at the nucleic acid level or as an expression product of said genes at the mRNA level or protein level.

25. The method according to claim 24 wherein the expression level is determined by an array of oligonucleotide probes specific for said T2D genes.

26. An in vitro method to monitor T2D progression in a critical person, said method comprising determining the expression level of at least two T2D marker genes selected from ARF1, CAPZB, CAT, CCR2, CCR7, CD14, CD3D, CFL1, COX7C, CRF, CRP, CSCR4, DDIT3, EIF4A2, EIF4G2, ELA2, FOS, FTH1, GLRX, GNB2, GPX1, GSTP1, HMOX1, HNRPK, HSPA1A, HSPA5, HSPCB, ICAM3, IL11, IL2, IL2RB, IL2RG, IL3, IL5, LTF, MAZ, MYL6, OGG1, PRDX1, PRDX5, RPL13A, RPL38, RPS18, SERPINE1, SIRT1, SMT3H2, SRP14, TNFAIP3, TNFRSF1B, UBB, UBC, and UCP2 from at least two consecutive biological samples taken from said person; and measuring any change in the expression levels of said T2D genes; wherein a change in expression levels of said T2D genes into expression levels similar to the expression levels of said T2D genes in a representative set of non-T2D controls indicates a positive disease progression.

27. An assay to determine whether an agent or method of treatment is able to prevent or reduce the onset of T2D in a critical person, said assay comprising determining the expression level of at least two T2d marker genes selected from ARF1, CAPZB, CAT, CCR2, CCR7, CD14, CD3D, CFL1, COX7C, CRF, CRP, CSCR4, DDIT3, EIF4A2, EIF4G2, ELA2, FOS, FTH1, GLRX, GNB2, GPX1, GSTP1, HMOX1, HNRPK, HSPA1A, HSPA5, HSPCB, ICAM3, IL11, IL2, IL2RB, IL2RG, IL3, IL5, LTF, MAZ, MYL6, OGG1, PRDX1, PRDX5, RPL13A, RPL38, RPS18, SERPINE1, SIRT1, SMT3H2, SRP14, TNFAIP3, TNFRSF1B, UBB, UBC, and UCP2 both in the presence and in the absence of said agent or method of treatment; and comparing the expression levels of said T2D genes with expression levels of said T2D genes in a representative set of non-T2D controls; wherein a modification of said expression levels is indicative that said agent or method of treatment is capable of preventing or reducing the onset of T2D in a critical person.

28. An assay according to claim 27 wherein said at least two T2D genes are selected from CRP, IL2RB, CRF (C1QL1), ELA2, RPL38, FTH1, MYL6, ARF1, EIF4G2, TNFRSF1B, RPL13A, CD3D, GNB2, HSPA1A, MAZ, COX7C, SRP14, CXCR4, UBC, SMT3H2, CD14, HSPCB, CFL1, CCR7, IL5, HMOX1, IL11, OGG1, SERPINE 1, PRDX1, GPX1, IL2RG, UBB, and UCP2.

29. The assay according to claim 27 further comprising comparing the expression level of said T2D genes with the pre-established mean expression levels observed in a representative set of samples taken from non-T2D controls.

30. The assay according to claim 27 further comprising calculating the risk of T2D in said critical person as the cumulative value of the DTCO (distance to cut off) of each of the genes assessed, where R (Risk)=ΣDTCO, and wherein an increase in R is indicative of an increased risk in developing T2D.

31. The assay according to claim 30 wherein the risk is scored on an incremental scale from 0 to 10.
